(19) United States
(12) Patent Application Publication
(10) Pub. No.: US 2025/0148369 A1
(43) Pub. Date: May 8, 2025

(54) INTRODUCING JITTER TO TRAIN AND/OR ASSESS THE STABILITY OF A MACHINE LEARNING MODEL

(71) Applicant: Senseonics, Incorporated, Germantown, MD (US)

(72) Inventor: Chad Michael Hicks, Germantown, MD (US)

(73) Assignee: Senseonics, Incorporated, Germantown, MD (US)

(21) Appl. No.: 18/932,951

(22) Filed: Oct. 31, 2024

Related U.S. Application Data
(60) Provisional application No. 63/596,745, filed on Nov. 7, 2023.

(51) Int. Cl. G06N 20/00; G06N 7/00

(52) U.S. Cl. CPC G06N 20/00; G06N 7/00

(57) ABSTRACT

Systems, apparatuses, and methods for training and/or assessing the stability of a machine learning (ML) model. Training and/or assessing the stability may include, for each input sample n of N input samples, for each perturbation q of Q perturbations: determining a perturbed input sample n_{q} by perturbing the input sample n and using the ML model to obtain a perturbed output y_{qn} based on the perturbed input sample n_{q}. Training and/or assessing the stability may include, for each input sample n of the N input samples, aggregating the perturbed outputs y_{qn} to obtain an aggregate perturbed output yₙ of the Q perturbations for the input sample n. Training the ML model may include updating one or more parameters of the ML model based on at least the aggregate perturbed outputs yₙ. Assessing the stability may include aggregating the aggregate perturbed outputs yₙ (or relative output variations yₙ^{rel}).

### CROSS-REFERENCE TO RELATED APPLICATION

The present application claims the benefit of priority to U.S. Provisional Application Ser. No. 63/596,745, filed on Nov. 7, 2023, which is incorporated herein by reference in its entirety.

### BACKGROUND

### Field of Invention

The present invention relates generally to assessing the stability of a machine learning (ML) model and to training the ML model. More particularly, the present invention relates to introducing jitter to assess the stability of an ML model and to train the ML model.

### Discussion of the Background

Loss functions are commonly used in supervised machine learning (ML) problems to define the optimization criteria that the ML training process will attempt to solve. As shown in FIG. 1, a loss function compares the predictions of an ML model with the expected values (i.e., the truth values) and returns some form of loss, which is a measure of the quality of the model predictions. Common loss functions include Mean Squared Error (MSE), Mean Absolute Error (MAE), and Cross-Entropy Loss. For example, MSE returns the sum of the squares of each prediction's error from expected value. One feature of these loss functions is that the loss value is dependent only on the relative difference between prediction and expected values. This makes them appropriate for a wide range of problems. An ML algorithm attempt to minimize the loss as calculated by the loss function in order to solve the ML problem.

A loss function generally returns the point-wise gradient and Hessian of the actual loss function (i.e., first and second order derivatives with respect to prediction, respectively) in order to inform the ML algorithm how to modify model parameters of the ML model in order to improve the ML model for the next iteration. In the case of MSE, the gradient is just twice the error, and the Hessian is the number two.

Different machine learning (ML) models incorporate different methods for determining the performance and stability of the ML model. Conventional methods for determining the performance and stability of an ML model include cross-validation in which different data subsets are used in training the ML model at different iterations to assess and improve stability. Conventional methods for determining the performance and stability of an ML model also include the Population Stability Index and Characteristic Stability Index for assessing how prediction and features distributions shift over time.

### SUMMARY

One issue with the conventional methods for determining the performance and stability of an ML model described above is that they look at the overall statistical distributions in aggregate rather than looking at how changes to individual inputs map to changes in individual outputs. For example, the conventional methods assess changes by looking at histogram bin value changes in a distribution, and this can lead to inaccuracy if some change causes two bins to partially swap places.

Aspects of the invention relate to a jittering (also referred herein to as perturbation) approach for determining the performance and stability of an ML model. The jittering approach may address the shortcomings of the conventional methods. According to the jittering approach, one would expect that a well-behaved ML model would produce a relative output variation similar to the input perturbation. For example, if the input features to an ML model were jittered by 1%, one would expect the prediction values output by the ML model to vary by about 1%. On the other hand, if the prediction values output by the ML model varied by 50% for a 1% input perturbation, the output variation would be indicative of instability of the ML model.

In some aspects, the jittering approach may determine stability of an ML model on a point-wise basis to look for input feature space regions of instability. In some aspects, the jitter approach may additionally or alternatively aggregate the stability on the point-wise basis to produce an overall stability score for the ML model. In some aspects, the amount of input perturbation may be adjusted (e.g., by a user). For example, the input perturbation does not have to be 1%.

In some aspects, in contrast with the conventional methods, the jittering approach may focus on mapping individual response of the ML model to individual input samples. In some aspects, this focus may allow the jittering approach to track changes that do not affect the overall statistical distributions of the inputs to or predictions of the ML model. One application of the jittering approach is to visualize or model the stability of the ML model with respect to various regions of the input feature space. In some aspects, the jittering approach may be used to augment the loss function during training of the ML model so that the loss function incorporates stability as a loss metric.

One aspect of the invention may provide a method. The method may include, for each input sample n of N input samples: for each perturbation q of Q perturbations: determining a perturbed input sample n_{q} by perturbing the input sample n and using a machine learning (ML) model to obtain a perturbed output y_{qn} based on the perturbed input sample n_{q}. The method may include, for each input sample n of the N input samples, aggregating the perturbed outputs y_{qn} of the Q perturbations to obtain an aggregate perturbed output yₙ of the Q perturbations for the input sample n. N may be an integer greater than 1, and Q may be an integer greater than or equal to 1.

In some aspects, the method may further include adjusting the ML model based on the aggregate perturbed outputs yₙ for the N input samples. In some aspects, adjusting the ML model based on the aggregate perturbed outputs yₙ for the N input samples may include determining, for each input sample n of the N input samples, a gradient and a Hessian of the aggregate perturbed output yₙ of the Q perturbations for the input sample n. In some aspects, adjusting the ML model based on the aggregate perturbed outputs for the N input samples may include adjusting the ML model based on the gradients and Hessians. In some aspects, adjusting the ML model based on the gradients and Hessians may include for each input sample n of the N input samples: combining the gradient and the Hessian of the aggregate perturbed output yₙ of the Q perturbations for the input sample n with a gradient and Hessian, respectively, of a performance-based loss function to create an overall loss function; using an optimization algorithm to determine parameters of the ML model the minimize the overall loss function; and adjusting the ML model to have the determined parameters of the ML model. In some aspects, the optimization algorithm may be a gradient descent algorithm, a stochastic gradient descent algorithm, or an Adam optimization algorithm.

In some aspects, aggregating the perturbed outputs y_{qn} of the Q perturbations for the input sample n may include determining a mean y̅ₙ̅ of the perturbed outputs y_{qn} of the Q perturbations. In some aspects, aggregating the perturbed outputs y_{qn} of the Q perturbations for the input sample n may include determining a standard deviation of the perturbed outputs y_{qn} of the Q perturbations for the input sample n, and the aggregate perturbed output yₙ of the Q perturbations for the input sample n may be the standard deviation. In some aspects, aggregating the perturbed outputs y_{qn} of the Q perturbations for the input sample n may include determining a variance of the perturbed outputs y_{qn} of the Q perturbations for the input sample n, and the aggregate perturbed output yₙ of the Q perturbations for the input sample n may be the variance.

In some aspects, the variance v of the perturbed outputs y_{qn} of the Q perturbations for the input sample n may be calculated as

$$\frac{{Σ ( {y}_{q n} - \overline{{y}_{n}} )}^{2}}{Q - 1} .$$

In some aspects, the gradient of the aggregate perturbed output yₙ of the Q perturbations for the input sample n may be calculated as

$$\frac{\partial v}{\partial {y}_{q n}} = \frac{2 {Σ}_{q} ( {y}_{q n} - \overline{{y}_{n}} )}{Q - 1} .$$

In some aspects, the gradient of the aggregate perturbed output yₙ of the Q perturbations for the input sample n may be calculated as

$$\frac{\partial v}{\partial {y}_{q n}} = \frac{2 {Σ}_{q} ( {y}_{q n} - \overline{{y}_{n}} )}{Q - 1} .$$

In some aspects, the gradient of the aggregate perturbed output yₙ of the Q perturbations for the input sample n may be calculated in polar coordinates, and the phase information may be discarded. In some aspects, the Hessian of the aggregate perturbed output yₙ of the Q perturbations for the input sample n may be calculated as

$$\frac{{\partial }^{2} v}{{\partial }^{2} {y}_{q n}} = \frac{2 Q}{Q - 1} .$$

In some aspects, the method may further include aggregating the aggregate perturbed outputs yₙ for the N input samples to determine an estimate of the stability of the ML model. In some aspects, aggregating the perturbed outputs y_{qn} of the Q perturbations for the input sample n may include determining a mean y̅ₙ̅ of the perturbed outputs y_{qn} of the Q perturbations for the input sample n. In some aspects, aggregating the perturbed outputs y_{qn} of the Q perturbations for the input sample n may include determining a standard deviation of the perturbed outputs y_{qn} of the Q perturbations for the input sample n, and the aggregate perturbed output yₙ of the Q perturbations for the input sample n may be the standard deviation of the perturbed outputs y_{qn} of the Q perturbations for the input sample n.

In some aspects, aggregating the perturbed outputs y_{qn} of the Q perturbations for the input sample n may include determining a variance v of the perturbed outputs y_{qn} of the Q perturbations for the input sample n, and the aggregate perturbed output yₙ of the Q perturbations for the input sample n may be the variance v of the perturbed outputs y_{qn} of the Q perturbations for the input sample n. In some aspects, the variance v of the perturbed outputs y_{qn} of the Q perturbations for the input sample n may be calculated as

$$\frac{{Σ ( {y}_{q n} - \overline{{y}_{n}} )}^{2}}{Q - 1} .$$

In some aspects, aggregating the perturbed outputs y_{qn} of the Q perturbations for the input sample n may include determining a maximum output of the perturbed outputs y_{qn} of the Q perturbations for the input sample n, and the aggregate perturbed output yₙ of the Q perturbations for the input sample n may be the maximum output of the perturbed outputs y_{qn} of the Q perturbations for the input sample n. In some aspects, aggregating the perturbed outputs y_{qn} of the Q perturbations for the input sample n may include determining a minimum output of the perturbed outputs y_{qn} of the Q perturbations for the input sample n, and the aggregate perturbed output yₙ of the Q perturbations for the input sample n may be the minimum output of the perturbed outputs y_{qn} of the Q perturbations for the input sample n. In some aspects, aggregating the perturbed outputs y_{qn} of the Q perturbations for the input sample n may include determining a median of the perturbed outputs y_{qn} of the Q perturbations for the input sample n.

In some aspects, aggregating the aggregate perturbed outputs yₙ may include determining a mean of the aggregate perturbed outputs yₙ, and the estimate of the stability of the ML model may be based on the mean of the aggregate perturbed outputs yₙ. In some aspects, aggregating the aggregate perturbed outputs yₙ may include determining a standard deviation of the aggregate perturbed outputs yₙ, and the estimate of the stability of the ML model may be based on the standard deviation of the aggregate perturbed outputs yₙ. In some aspects, aggregating the aggregate perturbed outputs yₙ may include determining a variance of the aggregate perturbed outputs yₙ, and the estimate of the stability of the ML model may be based on the variance of the aggregate perturbed outputs yₙ. In some aspects, aggregating the aggregate perturbed outputs yₙ may include determining a maximum aggregate perturbed output of the aggregate perturbed outputs yₙ, and the estimate of the stability of the ML model may be based on the maximum aggregate perturbed output of the aggregate perturbed outputs yₙ. In some aspects, aggregating the aggregate perturbed outputs yₙ may include determining a minimum aggregate perturbed output of the aggregate perturbed outputs yₙ, and the estimate of the stability of the ML model may be based on the minimum aggregate perturbed output of the aggregate perturbed outputs yₙ. In some aspects, aggregating the aggregate perturbed outputs yₙ may include determining a median of the aggregate perturbed outputs yₙ, and the estimate of the stability of the ML model may be based on the median of the aggregate perturbed outputs yₙ.

In some aspects, the method further include, for each input sample n of the N input samples, determining a relative perturbed output yₙ^{rel} based on the aggregate perturbed output yₙ of the Q perturbations for the input sample n. In some aspects, the relative perturbed output yₙ^{rel} may be determined as yₙ/Δy, where Δy is the difference between the largest output of the ML model and the smallest output of the ML model. In some aspects, the method may further include aggregating the relative perturbed outputs to determine an estimate of the stability of the ML model.

In some aspects, aggregating the relative perturbed outputs may include determining a mean of the relative perturbed outputs, and the estimate of the stability of the ML model may be the mean of the relative perturbed outputs. In some aspects, aggregating the relative perturbed outputs may include determining a standard deviation of the relative perturbed outputs, and the estimate of the stability of the ML model may be the standard deviation of the relative perturbed outputs. In some aspects, aggregating the relative perturbed outputs may include determining a variance of the relative perturbed outputs, and the estimate of the stability of the ML model may be the variance of the relative perturbed outputs. In some aspects, aggregating the relative perturbed outputs may include determining a maximum relative perturbed output of the relative perturbed outputs, and the estimate of the stability of the ML model may be the maximum relative perturbed output of the relative perturbed outputs. In some aspects, aggregating the relative perturbed outputs may include determining a minimum relative perturbed output of the relative perturbed outputs, and the estimate of the stability of the ML model may be the minimum aggregate perturbed output of the relative perturbed outputs. In some aspects, aggregating the relative perturbed outputs may include determining a median of the relative perturbed outputs, and the estimate of the stability of the ML model may be the median of the relative perturbed outputs.

In some aspects, perturbing the input sample n to determine the perturbed input sample n_{q} may include, for each feature m of M features of the input sample n: determining a perturbation within an input sample feature perturbation range sₘ for the feature m; and applying the perturbation on the feature m of the input sample n to obtain a perturbed input sample feature m_{q}. In some aspects, the perturbed input sample n_{q} may include the perturbed input sample features m_{q}, and M may be an integer greater than or equal to 1. In some aspects, the perturbation within the input sample feature perturbation range sₘ for the feature m may be determined using a sampling scheme (e.g., Monte Carlo, Latin Hypercube, or grid). In some aspects, the method may further include determining the input sample feature perturbation range sₘ for the feature m. In some aspects, determining the input sample feature perturbation range sₘ for the feature m may include multiplying a feature value range Δm for the feature m of the input sample by a fractional perturbation size S.

Another aspect of the invention may provide an apparatus including processing circuitry and a memory containing instructions executable by the processing circuitry, whereby the apparatus is operative to perform the method of any one of the aspects above.

Still another aspect of the invention may provide an apparatus adapted to perform the method of any one of the aspects above.

Yet another aspect of the invention may provide an apparatus configured to: for each input sample n of N input samples: for each perturbation q of Q perturbations: determine a perturbed input sample n_{q} by perturbing the input sample n and use a machine learning (ML) model to obtain a perturbed output y_{qn} based on the perturbed input sample n_{q}. The apparatus may be configured to aggregate the perturbed outputs y_{qn} of the Q perturbations to obtain an aggregate perturbed output yₙ of the Q perturbations for the input sample n. N may be an integer greater than 1, and Q may be an integer greater than or equal to 1.

In some aspects, the apparatus may be further configured to adjust the ML model based on the aggregate perturbed outputs for the N input samples. In some aspects, the apparatus may be further configured to aggregate the aggregate perturbed outputs for the N input samples to determine an estimate of the stability of the ML model. In some aspects, the apparatus may be further configured to, for each input sample n of the N input samples, determine a relative perturbed output yₙ^{rel} based on the aggregate perturbed output yₙ of the Q perturbations for the input sample n. In some aspects, the apparatus may be further configured to aggregate the relative perturbed outputs to determine an estimate of the stability of the ML model. In some aspects, the apparatus may include processing circuitry and a memory, and the memory may include instructions executable by the processing circuitry, whereby the apparatus is operative to perform the running, determining, and aggregating.

Further variations encompassed within the systems and methods are described in the detailed description of the invention below.

### BRIEF DESCRIPTION OF THE DRAWINGS

The accompanying drawings, which are incorporated herein and form part of the specification, illustrate various, non-limiting embodiments of the present invention. In the drawings, like reference numbers indicate identical or functionally similar elements.

FIG. 1 illustrates a loss function that compares the predictions of an ML model with the expected values (i.e., the truth values) and returns some form of loss, which is a measure of the quality of the model predictions.

FIG. 2 is a schematic view illustrating an exemplary machine learning (ML) model stability assessment and training system according to some aspects.

FIG. 3 illustrates an example of an input sample n, Q perturbed input samples n_{q}, a prediction value pₙ, perturbed prediction values/outputs y_{qn} according to some aspects.

FIG. 4A illustrates ML model assessment according to some aspects.

FIG. 4B illustrates ML model training according to some aspects.

FIG. 5 is a flowchart illustrating a process for training an ML model according to some aspects.

FIG. 6 is a flowchart illustrating a process for assessing the stability of an ML model according to some aspects.

FIG. 7 is a flowchart illustrating a process for assessing the stability of an ML model according to some aspects.

FIG. 8 is a schematic view illustrating an exemplary analyte monitoring system according to some aspects.

FIG. 9 is a schematic view illustrating an exemplary analyte sensor of the analyte monitoring system according to some aspects.

FIG. 10 is a schematic view illustrating an exemplary transceiver of the analyte monitoring system according to some aspects.

FIG. 11 is a schematic view illustrating an exemplary display device of the analyte monitoring system according to some aspects.

FIG. 12 is a schematic view illustrating an exemplary computer of the ML model stability assessment and training system or the analyte monitoring system according to some aspects.

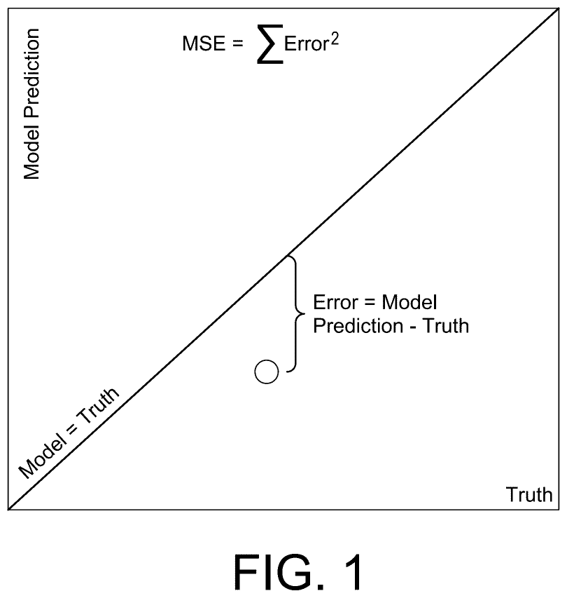

### DETAILED DESCRIPTION OF PREFERRED EMBODIMENTS

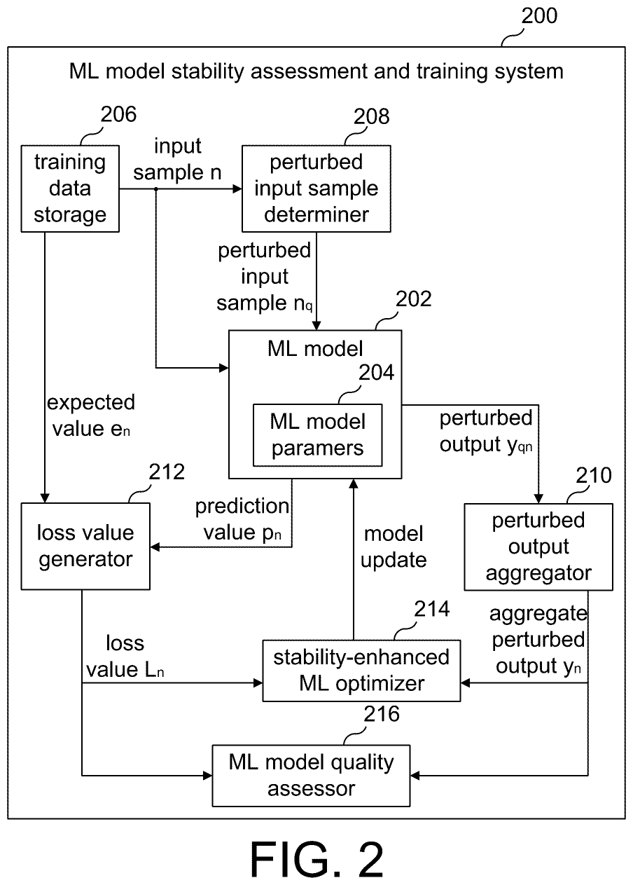

FIG. 2 is a schematic view of an exemplary machine learning (ML) model stability assessment and training system 200 embodying aspects of the present invention. In some aspects, as shown in FIG. 2, the system 200 may include an ML model 202, a training data storage device 206, a perturbed input sample determiner 208, a perturbed output aggregator 210, a loss value generator 212, a stability-enhanced ML optimizer 214, and/or an ML model quality assessor 216. In some aspects, the system 200 may assess the stability of the ML model 202. In some aspects, the system 200 may train the ML model 202 using at least the assessed stability of the ML model 202.

In some aspects, the training data storage device 206 may include one or more non-volatile storage devices and/or one or more volatile storage devices (e.g., random access memory (RAM)). In some aspects, the training data storage device 206 may store a training data set for training the ML model 202. In some aspects, the training data set may include ML model input samples and, for each of the input samples, an expected value for the input sample. In some aspects, each of the input samples of the training data set may include M features, where M is an integer greater than or equal to one.

In some aspects, the ML model 202 may receive an input sample n of the training data set from the training data storage device 206 and generate a prediction value pₙ as an output. In some aspects, the loss value generator 212 may receive the prediction value pₙ output by the ML model 202 and the corresponding expected value eₙ, which may be the value expected for the input sample n used by the ML model 202 to generate the prediction value pₙ. In some aspects, the loss value generator 212 may determine a loss value Lₙ indicative of an error between the prediction value pₙ and the corresponding expected value eₙ. In some aspects, the process may be repeated for the rest of the input samples and expected values of the training data set, and the loss value generator 608 may determine loss values indicative of errors between prediction values output by the ML model 202 and the corresponding expected values.

In some aspects, the training data storage device 106 may additionally or alternatively store N input samples that may be used for assessing the stability of the ML model 102. In some aspects in which the training data storage device 106 stores a training data set including input samples and corresponding expected values, the N input samples may be a subset of or the same as the input samples of the training data set. However, this is not required, and, in some alternative aspects in which the training data storage device 106 stores a training data set, one or more of the N input samples may be in addition to the input samples of the training data set. In some other alternative aspects, the training data storage device 106 may store the N input samples but may not store a training data set. In some aspects, each of the N input samples may include M features, where M is an integer greater than or equal to one.

In some aspects, the perturbed input sample determiner 208 may receive the input samples n of the N input samples. In some aspects, for each input sample n of the N input samples, for each perturbation q of Q perturbations, the perturbed input sample determiner 208 may determine a perturbed input sample n_{q} by perturbing the input sample n. In some aspects, for each perturbation q of Q perturbations, the perturbed input sample determiner 208 may apply a different set of perturbations to the M features of the input sample n. In some aspects, perturbations applied to the M features may perturb the M features by no more than a maximum amount (e.g., a maximum change of 1%). As a result, in some aspects, no feature f of the M features may change by more than the maximum amount. In an example in which the input sample n has 3 features, and the maximum amount is a change of 0.50%, in the first perturbation of the Q perturbations, the perturbed input sample determiner 208 may apply perturbations of +0.42%, −0.13%, and −0.13% to the first, second, and third features, respectively, of the input sample n, and, in the second perturbation of the Q perturbations, the perturbed input sample determiner 208 may apply perturbations of −0.50%, +0.46%, and 0.00% to the first, second, and third features, respectively, of the input sample n. Thus, in this example, the first through third features of perturbed input sample n₁ may have increased by 0.42%, decreased by 0.13%, and decreased 0.13%, respectively, and the first through third features of perturbed input sample n₂ may have decreased by 0.50%, increased by 0.46%, and not changed, respectively.

In some aspect, the ML model 202 may receive the perturbed input sample n_{q} from the perturbed input sample determiner 208 and generate a perturbed output y_{qn} as an output. In some aspects, the perturbed output aggregator 210 may receive, for each of the Q perturbations for an input sample n, a perturbed output y_{qn}. In some aspects, the perturbed output aggregator 210 may aggregate the perturbed outputs y_{qn} of the Q perturbations to obtain an aggregate perturbed output yₙ of the Q perturbations for the input sample n.

In some aspects, the ML model 202 may include one or more model parameters 204. In some aspects, the stability-enhanced ML optimizer 214 may receive the determined loss values Lₙ and/or the aggregate perturbed outputs yₙ and adjust the ML model 202 to reduce the loss of the ML model 202 and/or increase the stability of the ML model 202. In some aspects, adjusting the ML model 202 may include modifying one or more of the one or more model parameters 204 of the ML model 202. In some aspects, for each input sample n of the N input samples, the stability-enhanced ML optimizer 214 may receive the determined loss value Lₙ and the aggregate perturbed output yₙ and, if there is loss and/or instability, adjust the ML model 202 to reduce the loss of the ML model 202 and/or increase the stability of the ML model 202.

In some aspects, the ML model quality assessor 216 may receive the determined loss values Lₙ and/or the aggregate perturbed outputs yₙ and generate as assessment of the performance and/or stability of the ML model 202. In some aspects, for each input sample n of the N input samples, the ML model quality assessor 216 may receive the determined loss value Lₙ and the aggregate perturbed output yₙ. In some aspects, the ML model quality assessor 216 may aggregate the aggregate perturbed outputs yₙ for the N input samples.

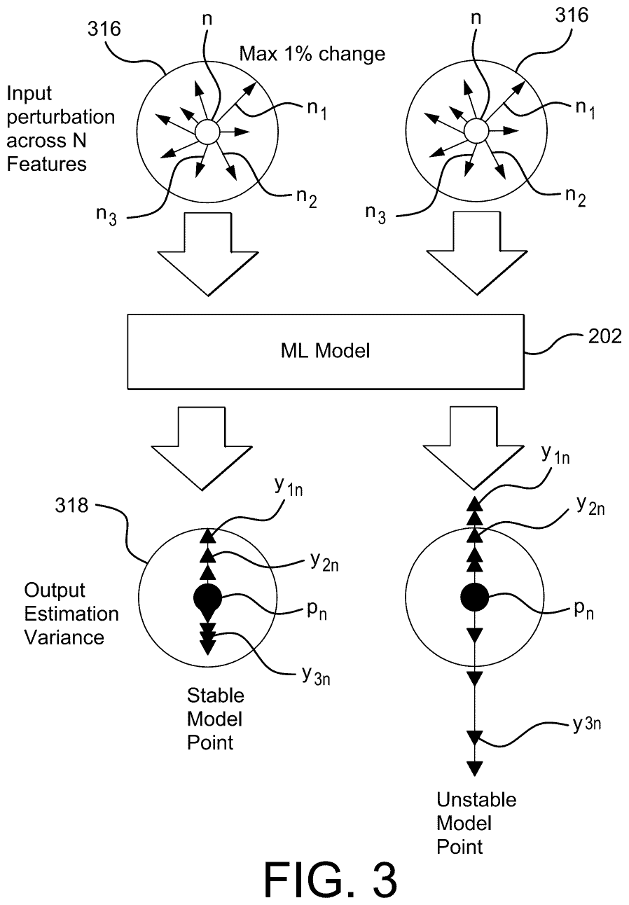

FIG. 3 illustrates an example of an input sample n and Q perturbed input samples n_{q}, which may be output by the perturbed input sample determiner 208. In the example shown in FIG. 3, there are eight perturbations (i.e., Q=8), and the maximum amount of perturbation applied to the features of the input sample n is a change of 1%. In FIG. 3, the perturbed input samples n_{q} are shown as arrows from the input sample n. In FIG. 3, only perturbed input samples n₁, n₂, and n₃ of perturbed input samples n₁ through n₈ are labeled. In FIG. 3, the circle 316 represents the maximum perturbation of 1%. FIG. 3 illustrates a prediction value pₙ an output the ML model 202 based on the input sample n. FIG. 3 also illustrates the perturbed prediction values/outputs y_{qn} output by the ML model 202 based on the perturbed input samples n_{q}, respectively. In FIG. 3, the perturbed outputs y_{qn} are shown as arrows from the prediction value pₙ. In FIG. 3, only perturbed outputs y₁ₙ, y₂ₙ, and y₃ₙ of perturbed outputs y₁ₙ through y₈ₙ are labeled. In FIG. 3, the circle 318 represents a 1% change to the prediction value pₙ, which corresponds to the maximum perturbation of 1% applied to the features of input sample n when generating the perturbed input samples n_{q}. The left side of FIG. 3 illustrates perturbed outputs y_{qn} produced by a relatively stable ML model 202, and the right side of FIG. 3 illustrates perturbed outputs y_{qn} produced by a relatively unstable ML model 202. As shown in FIG. 3, the perturbed outputs y_{qn} produced by a relatively unstable ML model 202 would have a greater variation than the perturbed outputs y_{qn} produced by a relatively stable ML model 202. In this way, the system 200 may determine stability on a point-wise basis (e.g., for each input sample n) to look for input feature space regions of instability, and/or the system 200 may aggregate stabilities determined for the N input samples to produce an overall stability score for the ML model 202.

In some aspects, the system 200 may receive one or more of the following as inputs: (i) the ML model 202 to test, (ii) a list of N input points with M features to use for evaluating the ML model 200, (iii) the relative size S of the jitter (e.g., 0.50%, 0.75%, 1.00%, 1.50%, 2.00%, 5.00%, or 10.00%), and/or (iv) the number Q of perturbations to apply to each input point. In some aspects, the relative size S may be a fraction or a percentage that gets converted to a fraction by dividing by 100. In some alternative aspects, if all of the M input features are normalized, then an absolute size (instead of a relative size) may be used for the jitter. In some aspects, the system 200 may include a default relative size of the jitter (e.g., 1%) to use if no relative size S of the jitter is specified and/or a default number of perturbations Q to use if no number of perturbations is specified.

In some aspects, assessing the stability of the ML model 202 may include the system 200 (e.g., the perturbed input sample determiner 208 of the system 200), for each feature m E 1 . . . M, (i) converting the fractional jitter size, S, to the absolute amount of jitter for that feature, sₘ, and (ii) using the relation sₘ=S·Δm, where Δm is the feature extent, which may be the largest feature value minus the smallest. The feature extent Δm may also be referred to as a feature value range herein. In some aspects, assessing the stability of the ML model 202 may include the system 200 (e.g., the perturbed input sample determiner 208 of the system 200), for each input sample n ∈ 1 . . . N, for each perturbation q ∈ 1 . . . Q, for each feature m ∈ 1 . . . M, determining the perturbation q to be applied to the feature m of the input sample n such that the perturbed feature m_{q} of the perturbed input sample n_{q} lies within sₘ of the feature m of the input sample n. In some aspects, sampling may be used to determine the perturbations q to be applied to the features m of the input samples n. In some aspects, the sampling scheme may be, for example and without limitation, Monte Carlo, Latin Hypercube, or grid.

In some aspects, assessing the stability of the ML model 202 may include the system 200 (e.g., the perturbed input sample determiner 208 of the system 200), for each input sample n ∈ 1 . . . N, for each perturbation q ∈ 1 . . . Q, providing the perturbed input sample n_{q} to the ML model 202, and the ML model 202 may produce a perturbed output y_{qn} based on the perturbed input sample n_{q}.

In some aspects, assessing the stability of the ML model 202 may include the system 200 (e.g., the perturbed output aggregator 210), for each input sample n ∈ 1 . . . N, statistically aggregating the Q perturbed outputs yon produced by the ML model 202 based on the Q perturbed input samples n_{q}. In some aspects, a first aggregation function yₙ=aggregate (y_{qn}) may be used to statistically aggregate the perturbed outputs y_{qn}. In some aspects, the first aggregation function may be, for example and without limitation, standard deviation or variance.

In some aspects, assessing the stability of the ML model 202 may include the system 200 (e.g., the ML model quality assessor 216 of the system 200) statistically aggregating the aggregate perturbed outputs yₙ for the N input samples. In some aspects, a second aggregation function y=aggregate (yₙ) may be used to statistically aggregate the aggregate perturbed outputs yₙ. In some aspects, the second aggregation function may be, for example and without limitation, mean, median, minimum, or maximum functions. In some aspects, the aggregate y of the aggregate perturbed outputs yₙ may be an estimate of the stability of the ML model 202. In some aspects, assessing the stability of the ML model 202 may include the system 200 (e.g., the perturbed output aggregator 210 and/or the ML model quality assessor 216 of the system 200) computing Δy, which is the estimation extent (e.g., the largest output of the ML model 202 minus the smallest output of the ML model 202). In some aspects, assessing the stability of the ML model 202 may include the system 200 (e.g., the ML model quality assessor 216 of the system 200) determining an overall relative value as

$${γ}_{n}^{r e l} = \frac{{y}_{n}}{Δ y} .$$

In some aspects, the overall relative value yₙ^{rel} may be an estimate of the stability of the ML model 202.

In some aspects, assessing the stability of the ML model 202 may include the system 200 (e.g., the perturbed output aggregator 210 and/or the ML model quality assessor 216 of the system 200) computing the relative output variation of each perturbed input sample n as

$${γ}_{n}^{r e l} = \frac{{y}_{n}}{Δ y} .$$

In some aspects in which the relative output variation yₙ^{rel} is computed, assessing the stability of the ML model 202 may include the system 200 (e.g., the ML model quality assessor 216 of the system 200) statistically aggregating the relative output variations yₙ^{rel} for the N input samples. In some aspects, a third function y^{rel}=aggregate (yₙ^{rel}) may be used to statistically aggregate the relative output variations yₙ^{rel} (e.g., instead of or in addition to statistically aggregating the aggregate perturbed outputs yₙ). In some aspects, the third aggregation function may be, for example and without limitation, mean, median, minimum, or maximum functions. In some aspects, the aggregate relative output variation y^{rel} may be an estimate of the stability of the ML model 202.

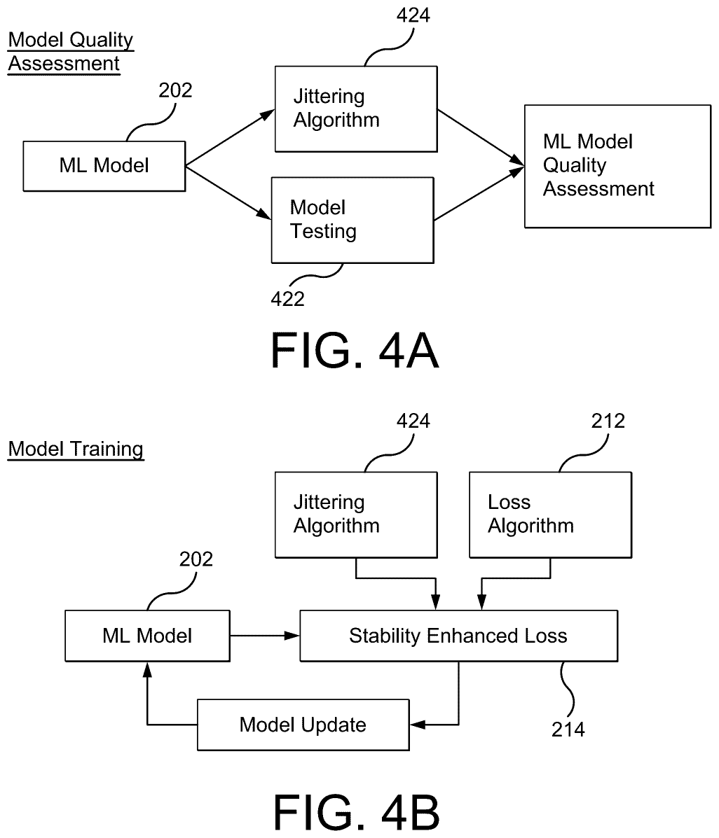

In some aspects, the value yₙ^{rel} may useful for plotting or analyzing the stability of the ML model 202 as a function of feature value. In some aspects, this may be done via scatterplot or some form of data modeling. In some aspects, the value y^{rel} may be useful for assessing the overall stability of the ML model 202. In some aspects, the value y^{rel} may be used to compare one ML model to another. In some aspects, as shown in FIG. 4A, model testing 422 (e.g., including comparing prediction values pₙ output by an ML model 202 to expected values eₙ) may be used to assess the performance of the ML model 202, a jittering algorithm 424 (e.g., as described above) may be used to assess the stability of the ML model 202, and both the assessed performance and the assessed performance of the ML model 202 may be used to assess the quality of the ML model 202. In some aspects, the model testing 422 may aggregate the loss values Lₙ generated by the loss value generator 212, which may be indicative of errors between the prediction values pₙ and the corresponding expected values eₙ. In some aspects, the model testing 422 may use the same loss function as the training algorithm, and, in some alternative aspects, the model testing 422 may use a different loss function than the training algorithm.

In some aspects, as shown in FIG. 4B, the jittering algorithm 424 may additionally or alternatively be used in combination with a custom or industry-standard performance-based loss function 212 to improve model stability during training of the ML model 202. In some aspects, as shown in FIG. 4B, the stability-enhanced ML optimizer 214 may combine the jittering algorithm 424 with a loss algorithm performed by the loss value generator 212 to produce a model update that optimizes both the performance and stability of the ML model 202. In some aspects, the system 200 (e.g., the loss value generator 212 of the system 200) may determine a gradient and Hessian from the loss function, the system 200 (e.g., the perturbed output aggregator 210 of the system 200) may determine a gradient and Hessian from the jitter, and the stability-enhanced ML optimizer 214 combine the gradient and Hessian from the loss function with the gradient and Hessian from the jitter and use the combined gradient and Hessian to update the ML model parameters 204 of the ML model 202. In some aspects, the gradients and Hessians may be combined by, for example and without limitation, simple addition or weighted addition. However, this is not required, and, in some alternative aspects, other function could be used to combine the gradients and Hessians.

In general terms, a machine learning gradient is the first derivative of a function with respect to the input features, and the Hessian is the second derivative. With respect to performance, the relevant function is the loss function (e.g., MSE, MAE, or Cross-Entropy Loss). With respect to jittering, the relevant function is the output variation. Various algorithms, such as, for example and without limitation, variance, standard deviation, and max-min, may be used as the function for computing the output variation. In some aspects using variance as the function for computing output variation, variance may be defined as, for example and without limitation,

$$v = \frac{{Σ ( {y}_{q n} - \overline{{y}_{n}} )}^{2}}{Q - 1} ,$$

where Q is the number of perturbed input samples n_{q} per input sample n, and the aggregate yₙ of the perturbed outputs y_{qn} is y̅ₙ̅, which is the mean of the output perturbed outputs y_{qn} of the perturbed input samples n_{q}. In some aspects, the gradient may be defined as

$$\frac{\partial v}{\partial {y}_{q n}} ,$$

and the Hessian may be defined as

$$\frac{{\partial }^{2} v}{{\partial }^{2} {y}_{q n}} .$$

These definitions may be very similar to the industry standard definition for MSE loss, with the exceptions that (i) the number of ML samples N is replaced by Q−1, (ii) the truth value of eₙ is replaced by the permutation mean y̅ₙ̅, (iii) the permuted points for a given yₙ are used instead of the original ML points, and (iv) the summation is performed over the permutation to create a single value for each ML training point. In this case, the gradient may be

$$\frac{\partial v}{\partial {y}_{qn}} = \frac{2 {\sum }_{q} ( {y}_{qn} - \overline{{y}_{n}} )}{Q - 1} ,$$

### and the Hessian may be

$$\frac{{\partial }^{2} v}{{\partial }^{2} {y}_{qn}} = \frac{2 Q}{Q - 1} .$$

In some aspects, the gradient and Hessian resulting from the jitter may be combined with the gradient and Hessian from the performance-based loss function to create an overall, stability-enhanced loss function. In some aspects, the gradients and Hessians may be combined by, for example, adding (e.g., simple or weighted adding of) the gradients and adding (e.g., simple or weighted adding of) the Hessians.

In some alternative aspects, because the aggregation of the individual jitters may cause the gradient resulting from the jitter as defined above to go to zero, the gradient resulting from jitter may instead be defined as the positive semidefinite distance between y_{qn} and y̅ₙ̅ and may be determined by taking the absolute value of the y_{qn}−y̅ₙ̅ prior to summation. In some other alternative aspects, the gradient resulting from jitter may instead be determined by performing the calculations in polar coordinates and discarding the phase information.

In some aspects, stability-enhanced training of the ML model 202 may include the system 200 (e.g., the perturbed input sample determiner 208 of the system 200), for each feature m ∈ 1 . . . M, (i) converting the fractional jitter size, S, to the absolute amount of jitter for that feature, sₘ, and (ii) using the relation sₘ=S·Δm, where Δm is the feature extent, which may be the largest feature value minus the smallest. The feature extent Δm may also be referred to as a feature value range herein. In some aspects, stability-enhanced training of the ML model 202 may include the system 200 (e.g., the perturbed input sample determiner 208 of the system 200), for each input sample n ∈ 1 . . . N, for each perturbation q ∈ 1 . . . Q, for each feature m ∈ 1 . . . M, determining the perturbation q to be applied to the feature m of the input sample n such that the perturbed feature m_{q} of the perturbed input sample n_{q} lies within sₘ of the feature m of the input sample n. In some aspects, sampling may be used to determine the perturbations q to be applied to the features m of the input samples n. In some aspects, the sampling scheme may be, for example and without limitation, Monte Carlo, Latin Hypercube, or grid.

In some aspects, stability-enhanced training of the ML model 202 may include the system 200 (e.g., the perturbed input sample determiner 208 of the system 200), for each input sample n ∈ 1 . . . N, for each perturbation q ∈ 1 . . . Q, providing the perturbed input sample n_{q} to the ML model 202, and the ML model 202 may produce a perturbed output y_{qn} based on the perturbed input sample n_{q}.

In some aspects, stability-enhanced training of the ML model 202 may include the system 200 (e.g., the perturbed output aggregator 210), for each input sample n ∈ 1 . . . N, statistically aggregating the Q perturbed outputs y_{qn} produced by the ML model 202 based on the Q perturbed input samples n_{q}. In some aspects, an aggregation function yₙ=aggregate (y_{qn}) may be used to statistically aggregate the perturbed outputs y_{qn}. In some aspects, the aggregation function may include determining the mean of the perturbed outputs y_{qn}. In some aspects, the aggregation function may include, for example and without limitation, determining variance, standard deviation, and/or max-min of the perturbed outputs y_{qn}· However, this is not required, and, in some alternative aspects, a different aggregation function may be used.

In some aspects, stability-enhanced training of the ML model 202 may include the system 200 (e.g., the perturbed output aggregator 210 of the system 200), for each input sample n ∈ 1 . . . N, calculating the gradient and Hessian resulting from the jitter. In some variance aspects, the gradient resulting from the jitter may be

$$\frac{\partial v}{\partial {y}_{qn}} = \frac{2 {\sum }_{q} ( {y}_{qn} - \overline{{y}_{n}} )}{Q - 1} ,$$

and the Hessian resulting from the jitter may be

$$\frac{{\partial }^{2} v}{{\partial }^{2} {y}_{qn}} = \frac{2 Q}{Q - 1} .$$

In some aspects, stability-enhanced training of the ML model 202 may include the system 200 (e.g., the loss value generator 212 of the system 200), for each input sample n ∈ 1 . . . N, calculating a gradient and a Hessian for the loss function. In some aspects, stability-enhanced training of the ML model 202 may include the system 200 (e.g., the stability-enhanced ML optimizer 214 of the system 200), for each input sample n ∈ 1 . . . N, combining the gradient and Hessian for the loss function with the gradient and Hessian resulting from the jitter and determining a model update, which may update one or more of the ML model parameters 204 of the ML model 202. In some aspects, the optimization function of the stability-enhanced ML optimizer 214 may be, for example, gradient descent or one of its descendants (e.g., a stochastic gradient descent (SGD) algorithm or Adam optimization algorithm).

Some aspects of the invention may be implemented in the Python programming language. An example of an implementation in the Python programming language is shown below. In some aspects, as shown below, the implementation may allow for both scoring of an ML model 202 and post training analysis as well as insertion into a loss function within the training cycles of model development.

```
class JitterLoss( ):
  def_{——}init_{——}(self, model, extent=0.1, n_samples=10):
    ‘‘‘
    Object Constructor
    Args:
      model (obj): A model object with a predict( ) function that accepts a
          pandas dataframe.
      jitter_extent (float, optional): Fractional jitter to apply to each
                  row in X. Defaults to 0.1.
      n_samples (int, optional): Number of jitter samples per row in X.
              Defaults to 10.
    ‘‘‘
    # input validation
    if extent <= 0.0: ValueError(‘Input extent must be a value greater than
                      zero.’)
    if not isinstance(n_samples, int) or n_samples < 2:
      ValueError(‘Input nsamples must be an integer greater or equal to 2.’)
    self.extent = extent
    self.nsamples = n_samples
    self.model = model
    self.hessian_value_for_variance = 2 * self.nsamples / (self.nsamples − 1)
  #**************************************************************************
  def jitter_model(self, X, aggregators={‘mean’:np.mean, ‘std’:np.std}):
    ‘‘‘
    Apply jittering to each sample point using an ML model
    Args:
      X (DataFrame): Input feature matrix
      aggregators (dict, optional): Dictionary of functions to apply. Key
                is the string name, value is a function. Defaults to
                {‘mean’:np.mean, ‘std’:np.std}.
    Returns:
      1) (DataFrame): The aggregated jitter results at each point
    ‘‘‘
    # Get jitterable columns, i.e. numeric columns, except for complex (which
    # is not handled): (i)nteger, (u)nsigned int, (f)loat
    jcols = [c for c in X.columns if X[c].dtype.kind in ‘iuf’]
    jcol_types = [X[c].dtype.kind for c in X.columns if X[c].dtype.kind in
              ‘iuf’]
    # Get the numeric extent of each jitterable column
    col_extents = [max(X[c]) − min(X[c]) for c in jcols]
    jitter_extents = np.array(col_extents) * self.extent
    jit_cols = dict(zip(jcols, list(zip(jcol_types, jitter_extents))))
    # Apply jittering to each point and collect aggregators for each point
    jitterer = partial(self.jitter_point, jit_cols=jit_cols,
                  aggregators=aggregators)
    result = X.apply(jitterer, axis=1)
    return result
  #**************************************************************************
  def jitter_point(self, row, jit_cols,
            aggregators={‘mean’:np.mean, ‘std’:np.std}):
    ‘‘‘
    Apply jittering to a single machine learning data point.
    Args:
      row (Series): Row of a Dataframe.
      jit_cols (dict): keys are column names to which jitter should be
            applied. Values are the column data type flag and the actual
            (not fractional) extent of jitter applied to each column.
      aggregators (dict, optional): aggregation functions keyed by string
                name(e.g. ‘mean’:np.mean) to apply to the jittered sample
                outputs. Defaults to {‘mean’:np.mean, ‘std’:np.std}.
    Raises:
      ValueError: the length of cols does not match the length of
                jitter_extents.
    Returns:
      1) (dict) Keyed by aggregator string name, the results of each
              aggregation function.
    ‘‘‘
    # Create jittering samples on the range [0, 1]
    sampling_engine = LatinHypercube(len(jit_cols))
    samples = sampling_engine.random(self.nsamples)
    # Convert the samples on 0, 1 to matrix of actual values
    output = { }
    index = − 1
    for item in row.index:
      if item in jit_cols.keys( ):
        index += 1
        if jit_cols[item][0] in ‘iu’: # integer, unsigned
            output[item] = row[item] + np.round((samples[:, index] − 0.5)
                    * jit_cols[item][1])
        else: # float
            output[item] = row[item] + (samples[:, index] − 0.5)
                    * jit_cols[item][1]
      else:
        output[item] = [row[item]] * self.nsamples
    row_jitter = pd.DataFrame(output)
    # Apply Point samples to model and aggregate the result
    y_pred = self.model.predict(row_jitter)
    results = {name:fcn(y_pred) for name, fcn in aggregators.items( )}
    return results
  #**************************************************************************
  def loss(self, input1, input2, X):
    ‘‘‘
    Compute the gradient and hessian of the machine learning jittering loss
    Args:
      input1 (Series): Truth or Model estimates. Not used but supplied by
            fit functions.
      input2 (Series): Truth or Model estimates. Not used but supplied by
            fit functions.
      X (DataFrame): Model's input feature matrix for testing jitter.
        Should match up with inputs 1 and 2.
    Returns:
      grad (Series): Gradient of the loss function
      hess (Series): Hessian of the loss function
```

The implemented loss function is closely related to the variance loss function and differs via the application of the absolute value function to y_qn−<y_n>. Thus the standard variance is var=sum(y_qn−<y_n>)**2)/(Q−1), while the function implements var-sum(|y_qn−<y_n>|**2)/(Q−1). In practice, the variance is unchanged; however, the gradient gains a discontinuity at y_qn−<y_n>. In practical terms this also allows for aggregation since the gradient sum of the standard variance will average out to zero when aggregated. Introducing the absolute value fixes this. In both cases, the Hessian is 2Q/Q−1.

```
  ‘‘‘
  # Compute gradient and hessian
  gradients = self.jitter_model(X,
```

aggregators={‘gradient’:self._gradient_for_variance})

```
  grad = [g[‘gradient’] for g in gradients]
  hess = np.ones(len(grad)) * self.hessian_value_for_variance
  return grad, hess
#**************************************************************************
def score(self, input1, input2, X, detailed=False, relative=False):
  ‘‘‘
  Compute the overall score of the model with respect to jittering.
  Args:
    input1 (Series): Truth or Model estimates. Not used, but supplied by
          fit functions.
    input2 (Series): Truth or Model estimates. Not used, but supplied by
          fit functions.
    X (DataFrame): Model's input feature matrix for testing jitter.
      Should match up with inputs 1 and 2.
    detailed (bool, optional): Whether to return a simple float for
```

```
  optimization requests (False) or a more detailed dictionary
  for analysis (True). Defaults to False.
```

relative (bool, optional): Whether to put the instability in relative

terms with respect to the span of y_est.

```
  Returns:
    score (float or dict): If detailed==False, a simple float indicating
        the mean of the standard deviation of the jittered responses
        across all model points. If detailed==True, a dictionary
        containing the following fields:
```

| | |
|---|---|
| - | avg instability: The mean instability of the jittered |
| | responses (same as the detailed==false response) |
| - | std instability: The standard deviation of the jittered |
| | instabilities |
| - | min instability: the minimum jittered instability |
| - | max instability: The maximum jittered instability |
| - | median instability: The median value of the jittered |
| | instabilities |
| - | point-wise instability: The jittered instability value at each |
| | tested point. |

```
  ‘‘‘
  # Compute the standard deviation of the jitter for each point
  jitters = self.jitter_model(X, aggregators={‘std’:np.std})
  instability = [j[‘std’] for j in jitters]
  # Convert the instability value to relative numbers
  if relative:
    y_est = input1 if isinstance(input1, xgb.DMatrix) else input2
    del_y = max(y_est) − min(y_est)
    instability /= del_y
  # Aggregate the per-point standard deviation to an overall value for the
  # model
  score = np.mean(instability)
  if detailed:
    score = {‘avg instability’:score,
```

```
  ‘std instability’:np.std(instability),
  ‘min instabilty’ :np.min(instability),
  ‘max instability’:np.max(instability),
  ‘median instability’:np.median(instability),
  ‘point-wise instability’:instability}
```

```
  return score
#**************************************************************************
def _gradient_for_variance(self, x):
  ‘‘‘
  Computes the gradient for the variance of x under the assumption that the
  gradient is positive semi-definite
  Args:
    x (numeric iterable): A list, series or 1D array of numeric values
  Returns:
    grad_x (float): The aggregated gradient of x
  Typically the gradient of x in machine learning is computed as
  2(y_qn − <y_n>)/(Q−1); however, when summed over numerous points, this
  averages to 0. In this application, we are interested in tracking how far
  off the mean we generally are, so the absolute value is introduced:
  gradient = 2 * sum( |y_qn−<y_n>| ) / (Q−1).
  ‘‘‘
  mean_x = np.mean(x)
  del_x = np.abs(np.array(x) − mean_x)
  grad_x = 2 * sum(del_x) / (len(x) − 1)
  return grad_x
```

In some aspects, the ML model 202 may predict blood glucose levels. That is, in some aspects, the prediction values generated by the ML model 202 may be predicted blood glucose levels. In some blood glucose level prediction aspects, the ML model input samples may include one or more interstitial fluid (ISF) glucose levels and associated time stamps. For example, in some aspects, the one or more ISF glucose levels may include a first ISF glucose level at a first time (e.g., to) and one or more previous ISF glucose levels at times (e.g., t₋₅, t₋₁₀, t₋₁₅, t₋₂₀, t₋₂₅) prior to the first time. In some blood glucose level prediction aspects, the ML model 202 may predict a blood glucose level at the first time (e.g., to), and, in some alternative blood glucose level prediction aspects, the ML model 202 may predict a blood glucose level at a future time (e.g., t₊₅, t₊₁₀, t₊₁₅, or t₊₂₀) relative to the first time. In some blood glucose level prediction aspects, the corresponding expected value may be an expected blood glucose level for the time (e.g., the first time or the future time) at which blood glucose level was predicted. In some aspects, the expected blood glucose levels may be capillary blood glucose levels (e.g., self-monitoring blood glucose (SMBG) levels obtained finger sticks and a blood glucose meter) or venous blood glucose levels (e.g., obtained by a biochemistry analyzer such as a YSI glucose analyzer). In some alternative aspects, the ML model 202 may predict blood analyte levels other than glucose (e.g., oxygen), and/or the ML model 202 may be for different applications/use cases. That is, aspects of the invention would apply to any data and ML model 202 in which both accuracy and stability is desirable for the predictions of the ML model 200. For example, aspects of the invention would be applicable to an ML model 200 that is (i) a regression model that attempts to predict a county's political leaning on the basis of features such as, for example and without limitation, income and/or housing density, (ii) a regression model that attempts to predict cancer life expectancy on the basis of features such as, for example and without limitation, tumor size, growth rate, and/or metabolic activity, or (iii) a regression model that attempts to predict light emitting diode (LED) life times based on features such as, for example and without limitation, semiconductor thickness, doping levels, and/or input current.

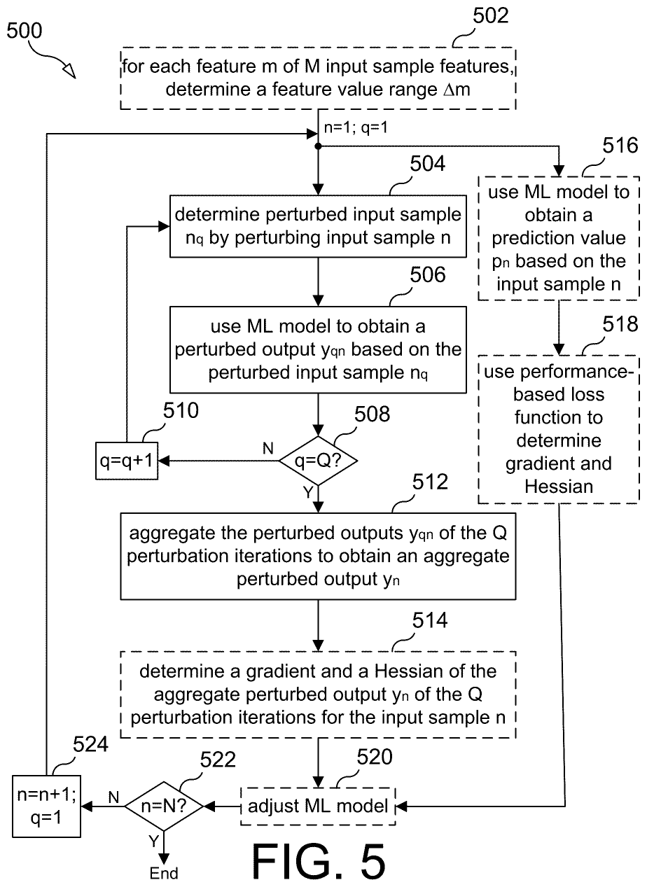

FIG. 5 illustrates a process 500 for training the ML model 202 according to some aspects. In some aspects, some or all of the steps of the process 500 may be performed by the ML model stability assessment and training system 200. In some aspects, some or all of the steps of the process 500 may be performed by the ML model 202, the perturbed input sample determiner 208, the loss value generator 212, the perturbed output aggregator 210, the stability-enhanced ML optimizer 214, and/or the ML model quality assessor 216 of the ML model stability assessment and training system 200.

In some aspects, as shown in FIG. 5, the process 500 may include a step 504 in which the system 200 (e.g., the perturbed input sample determiner 208 of the system 200), for an input sample n of N input samples and a perturbation q of Q perturbations, determines a perturbed input sample n_{q} by perturbing the input sample n. In some aspects, N may be an integer greater than 1, and Q may be an integer greater than or equal to 1. In some aspects, the process 500 may be initialized with the n equal to 1 and q equal to 1.

In some aspects, perturbing the input sample n to determine the perturbed input sample n_{q} in step 504 may include, for each feature m of M features of the input sample n, (i) determining a perturbation within an input sample feature perturbation range sₘ for the feature m and (ii) applying the perturbation on the feature m of the input sample n to obtain a perturbed input sample feature m_{q}. In some aspects, the perturbed input sample n_{q} may include the perturbed input sample features m_{q}, and M may be an integer greater than or equal to 1. In some aspects, the perturbation within the input sample feature perturbation range sₘ for the feature m may be determined using a sampling scheme (e.g., Monte Carlo, Latin Hypercube, or grid).

In some aspects, the input sample feature perturbation ranges sₘ may be default input sample feature perturbation ranges sₘ. In some alternative aspects, the input sample feature perturbation ranges sₘ may be inputs to the system 200 (e.g., user-entered inputs to the system 200). In some other alternative aspects, as shown in FIG. 5, the process 500 may include an optional step 502 in which the system 200 (e.g., the perturbed input sample determiner 208 of the system 200) determines, for each feature m of M features of the input sample n, the input sample feature perturbation range sₘ for the feature m. In some aspects, determining the input sample feature perturbation range sₘ for the feature m may include multiplying a feature value range Δm for the feature m of the input sample by a fractional perturbation size S.

In some additional alternative aspects (e.g., some aspects in which all features m of the input sample n are normalized), the input sample feature perturbation ranges sₘ may be the same for all of the features m, which may be a default value or a value input to the system 200.

In some aspects, as shown in FIG. 5, the process 500 may include a step 506 in which the system 200, for the input sample n and the perturbation q, uses the ML model 202 to obtain a perturbed output y_{qn} based on the perturbed input sample n_{q}. In some aspects, using the ML model 200 to obtain the perturbed output y_{qn} may include providing the perturbed input sample n_{q} to the ML model 200.

In some aspects, as shown in FIG. 5, the process 500 may include a step 508 in which the system 200 determines whether the perturbation q is the Qth perturbation. In some aspects, if the perturbation q is not the Qth perturbation, the process 500 may proceed from the step 508 to a step 510 in which the system 200 increments q, and the process 500 may then proceed to repeat steps 504 and 506 for the next perturbation of the Q perturbations for the input sample n. In some aspects, if the perturbation q is the Qth perturbation, the process 500 may proceed from the step 508 to a step 512.

In some aspects, as shown in FIG. 5, the process 500 may include the step 512. In some aspects, in step 512, the system 200 (e.g., the perturbed output aggregator 210 of the system 200) may aggregate the perturbed outputs y_{qn} of the Q perturbations for the input sample n to obtain an aggregate perturbed output yₙ of the Q perturbations for the input sample n. In some aspects, aggregating the perturbed outputs y_{qn} of the Q perturbations for the input sample n may include determining a mean y̅ₙ̅ of the perturbed outputs y_{qn} of the Q perturbations. In some alternative aspects, aggregating the perturbed outputs y_{qn} of the Q perturbations for the input sample n may include determining a standard deviation of the perturbed outputs y_{qn} of the Q perturbations for the input sample n, and the aggregate perturbed output yₙ of the Q perturbations for the input sample n may be the standard deviation. In some alternative aspects, aggregating the perturbed outputs y_{qn} of the Q perturbations for the input sample n may include determining a variance of the perturbed outputs y_{qn} of the Q perturbations for the input sample n, and the aggregate perturbed output yₙ of the Q perturbations for the input sample n may be the variance. In some variance aspects, the variance v of the perturbed outputs y_{qn} of the Q perturbations for the input sample n may be calculated as

$$\frac{\sum {( {y}_{qn} - \overline{{y}_{n}} )}^{2}}{Q - 1} .$$

In some aspects, as shown in FIG. 5, the process 500 may include an optional step 514 in which the system 200 (e.g., the perturbed output aggregator 210 of the system 200) determines a gradient and a Hessian of the aggregate perturbed output yₙ of the Q perturbations for the input sample n. In some aspects (e.g., some variance aspects), the gradient of the aggregate perturbed output yₙ of the Q perturbations for the input sample n may be calculated as

$$\frac{\partial v}{\partial {y}_{qn}} = \frac{2 {\sum }_{q} ( {y}_{qn} - \overline{{y}_{n}} )}{Q - 1} .$$

In some alternative aspects (e.g., some alternative variance aspects), the gradient of the aggregate perturbed output yₙ of the Q perturbations for the input sample n may be calculated as

$$\frac{\partial v}{\partial {y}_{qn}} = \frac{2 {\sum }_{q} ( \vert {y}_{qn} - \overline{{y}_{n}} \vert )}{Q - 1} .$$

In some alternative aspects, the gradient of the aggregate perturbed output yₙ of the Q perturbations for the input sample n may be calculated in polar coordinates, and the phase information may be discarded. In some aspects (e.g., some variance aspects), the Hessian of the aggregate perturbed output yₙ of the Q perturbations for the input sample n may be calculated as

$$\frac{{\partial }^{2} v}{{\partial }^{2} {y}_{qn}} = \frac{2 Q}{Q - 1} .$$

In some aspects, as shown in FIG. 5, the process 500 may include an optional step 516 in which the system 200 uses the ML model 200 to obtain a prediction value pₙ based on the input sample n. In some aspects, using the ML model 200 to obtain the prediction value pₙ may include providing the input sample n to the ML model 200.

In some aspects, as shown in FIG. 5, the process 500 may include an optional step 518 in which the system 200 (e.g., the loss value generator 212 of the system 200) using a performance-based loss function to obtain a gradient and a Hessian of the performance-based loss function with respect to the input sample n. In some aspects, determining the gradient and a Hessian of the performance-based loss function with respect to the input sample n may include using the loss value generator 212 to determine a loss value indicative of an error between the prediction value pₙ and the corresponding expected value Lₙ.

In some aspects, as shown in FIG. 5, the process 500 may include an optional step 520 in which the system 200 (e.g., the stability-enhanced ML optimizer 214 of the system 200) adjusts the ML model 202 based on at least the aggregate perturbed output yₙ for the input sample n. In some aspects, adjusting the ML model 202 in step 520 based on at least the aggregate perturbed outputs for the N input samples may include adjusting the ML model 202 based on at least the gradient and the Hessian of the aggregate perturbed output yₙ of the Q perturbations for the input sample n determined in step 514.

In some aspects, adjusting the ML model 202 in step 520 may include combining the gradient and the Hessian of the aggregate perturbed output yₙ of the Q perturbations for the input sample n determined in step 514 with a gradient and Hessian, respectively, of the performance-based loss function determined in step 518. In some aspects, combining the gradients and Hessians may create an overall loss function. In some aspects, adjusting the ML model 202 in step 520 may include using an optimization algorithm to determine parameters of the ML model 202 that minimize the overall loss function. In some aspects, the step 520 may adjust the ML model 202 to have the determined parameters of the ML model 202. In some aspects, the optimization algorithm may be, for example and without limitation, a gradient descent algorithm, a stochastic gradient descent algorithm, or an Adam optimization algorithm.

In some aspects, as shown in FIG. 5, the process 500 may include a step 522 in which the system 200 determines whether the input sample n is the Nth input sample. In some aspects, if the input sample n is not the Nth input sample, the process 500 may proceed from the step 522 to a step 524 in which the system 200 increments n and resets q to 1, and the process 500 may then proceed to repeat steps 504 through 520 for the next input sample of the N input samples. In some aspects, if the input sample n is the Nth input sample, the process 500 may end.

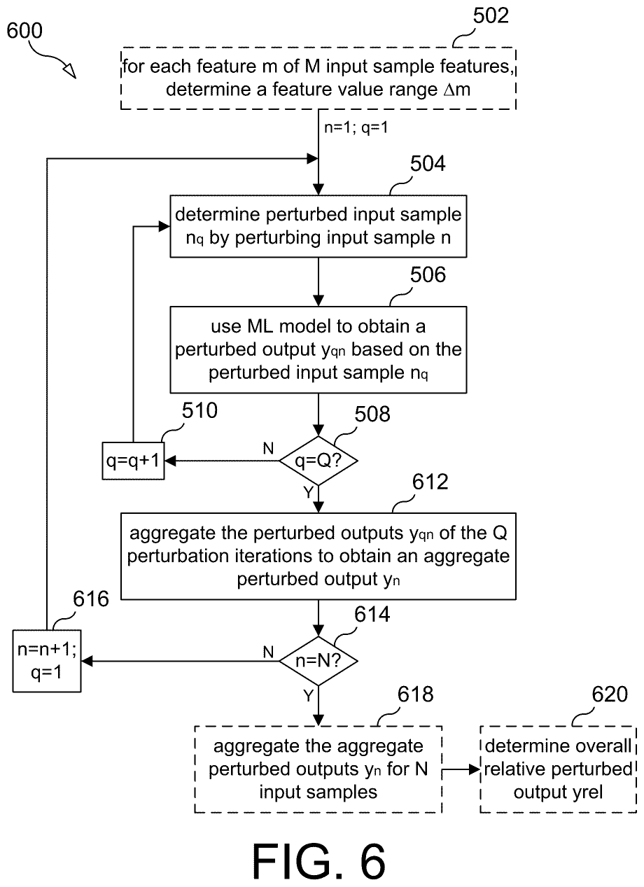

FIG. 6 illustrates a process 600 for assessing the performance of the ML model 202 according to some aspects. In some aspects, some or all of the steps of the process 600 may be performed by the ML model stability assessment and training system 200. In some aspects, some or all of the steps of the process 600 may be performed by the ML model 202, the perturbed input sample determiner 208, the loss value generator 212, the perturbed output aggregator 210, the stability-enhanced ML optimizer 214, and/or the ML model quality assessor 216 of the ML model stability assessment and training system 200.

In some aspects, as shown in FIG. 6, the process 600 may include steps 504, 506, 508, and 510, which may be the same as or similar to the steps 504, 506, 508, and 510 of the process 500 described above. In some aspects, as shown in FIG. 6, the process 600 may include the optional step 502, which may be the same as or similar to the optional step 502 of the process 500 described above.

In some aspects, as shown in FIG. 6, the process 600 may include a step 612. In some aspects, the process 600 may proceed from the step 508 to the step 612 if the perturbation q is the Qth perturbation. In some aspects, in step 612, the system 200 (e.g., the perturbed output aggregator 210 of the system 200) may aggregate the perturbed outputs y_{qn} of the Q perturbations for the input sample n to obtain an aggregate perturbed output yₙ of the Q perturbations for the input sample n.

In some aspects, aggregating the perturbed outputs y_{qn} of the Q perturbations for the input sample n in step 612 may include determining a mean y̅ₙ̅ of the perturbed outputs y_{qn} of the Q perturbations for the input sample n. In some aspects, aggregating the perturbed outputs y_{qn} of the Q perturbations for the input sample n in step 612 may include determining a standard deviation of the perturbed outputs y_{qn} of the Q perturbations for the input sample n, and the aggregate perturbed output yₙ of the Q perturbations for the input sample n may be the standard deviation of the perturbed outputs y_{qn} of the Q perturbations for the input sample n.

In some aspects, aggregating the perturbed outputs y_{qn} of the Q perturbations for the input sample n in step 612 may include determining a variance v of the perturbed outputs y_{qn} of the Q perturbations for the input sample n, and the aggregate perturbed output yₙ of the Q perturbations for the input sample n may be the variance v of the perturbed outputs y_{qn} of the Q perturbations for the input sample n. In some aspects, the variance v of the perturbed outputs y_{qn} of the Q perturbations for the input sample n may be calculated as

$$\frac{\sum {( {y}_{qn} - \overline{{y}_{n}} )}^{2}}{Q - 1} .$$

In some aspects, aggregating the perturbed outputs y_{qn} of the Q perturbations for the input sample n in step 612 may include determining a maximum output of the perturbed outputs y_{qn} of the Q perturbations for the input sample n, and the aggregate perturbed output yₙ of the Q perturbations for the input sample n may be the maximum output of the perturbed outputs y_{qn} of the Q perturbations for the input sample n. In some aspects, aggregating the perturbed outputs y_{qn} of the Q perturbations for the input sample n in step 612 may include determining a minimum output of the perturbed outputs y_{qn} of the Q perturbations for the input sample n, and the aggregate perturbed output yₙ of the Q perturbations for the input sample n may be the minimum output of the perturbed outputs y_{qn} of the Q perturbations for the input sample n. In some aspects, aggregating the perturbed outputs y_{qn} of the Q perturbations for the input sample n in step 612 may include determining a median of the perturbed outputs y_{qn} of the Q perturbations for the input sample n.

In some aspects, as shown in FIG. 6, the process 600 may include a step 614 in which the system 200 determines whether the input sample n is the Nth input sample. In some aspects, if the input sample n is not the Nth input sample, the process 600 may proceed from the step 614 to a step 616 in which the system 200 increments n and resets q to 1, and the process 600 may then proceed to repeat steps 504 through 512 for the next input sample of the N input samples. In some aspects, if the input sample n is the Nth input sample, the process 600 may proceed from the step 614 to an optional step 618.

In some aspects, as shown in FIG. 6, the process 600 may include the optional step 618. In some aspects, the optional step 618 may include the system 200 (e.g., the ML model quality assessor 216 of the system 200) aggregating the aggregate perturbed outputs yₙ for the N input samples to determine an estimate of the stability of the ML model 202. In some aspects, aggregating the aggregate perturbed outputs yₙ in step 618 may include using an aggregation function y=aggregate (yₙ) to aggregate the aggregate perturbed outputs yₙ. In some aspects, aggregating the aggregate perturbed outputs yₙ in step 618 may include determining a mean of the aggregate perturbed outputs yₙ, and the estimate of the stability of the ML model 202 may be based on the mean of the aggregate perturbed outputs yₙ. In some aspects, aggregating the aggregate perturbed outputs yₙ in step 618 may include determining a standard deviation of the aggregate perturbed outputs yₙ, and the estimate of the stability of the ML model 202 may be based on the standard deviation of the aggregate perturbed outputs yₙ. In some aspects, aggregating the aggregate perturbed outputs yₙ in step 618 may include determining a variance of the aggregate perturbed outputs yₙ, and the estimate of the stability of the ML model 202 may be based on the variance of the aggregate perturbed outputs yₙ. In some aspects, aggregating the aggregate perturbed outputs yₙ in step 618 may include determining a maximum aggregate perturbed output of the aggregate perturbed outputs yₙ, and the estimate of the stability of the ML model 202 may be based on the maximum aggregate perturbed output of the aggregate perturbed outputs yₙ. In some aspects, aggregating the aggregate perturbed outputs yₙ in step 618 may include determining a minimum aggregate perturbed output of the aggregate perturbed outputs yₙ, and the estimate of the stability of the ML model 202 may be based on the minimum aggregate perturbed output of the aggregate perturbed outputs yₙ. In some aspects, aggregating the aggregate perturbed outputs yₙ in step 618 may include determining a median of the aggregate perturbed outputs yₙ, and the estimate of the stability of the ML model 202 may be based on the median of the aggregate perturbed outputs yₙ.

In some aspects, as shown in FIG. 6, the process 600 may include an optional step 620 in which the system 200 (e.g., the ML model quality assessor 216 of the system 200) determines an overall relative perturbed output y^{rel} based on the aggregate y of the aggregate perturbed outputs yₙ for the N input samples that was determined in step 618. In some aspects, the overall relative perturbed output y^{rel} may be determined as

$${y}_{n}^{rel} = \frac{{y}_{n}}{Δ y} ,$$

where Δy is the difference between the largest output of the ML model 202 and the smallest output of the ML model 202. In some aspects, the estimate of the stability of the ML model 202 may be the overall relative perturbed output y^{rel}.

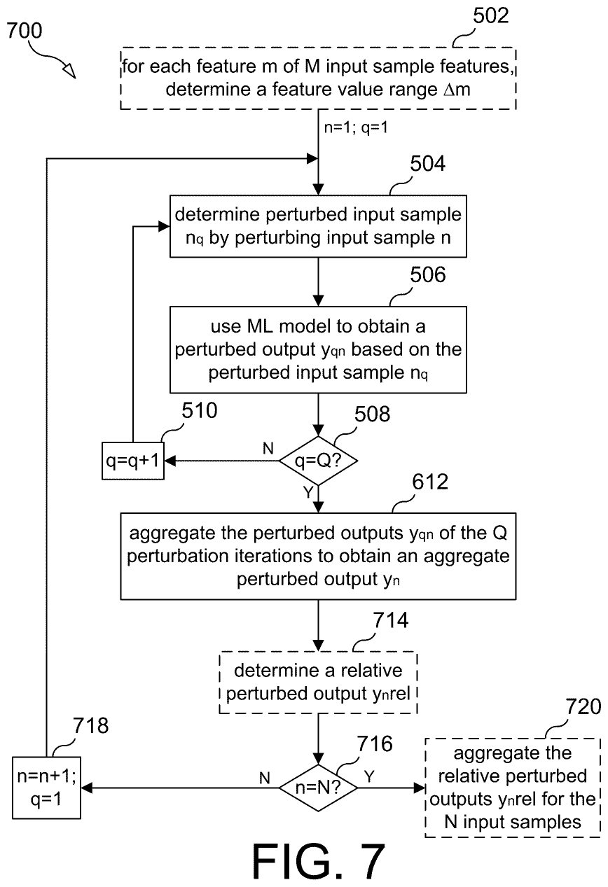

FIG. 7 illustrates a process 700 for assessing the performance of the ML model 202 according to some aspects. In some aspects, some or all of the steps of the process 700 may be performed by the ML model stability assessment and training system 200. In some aspects, some or all of the steps of the process 700 may be performed by the ML model 202, the perturbed input sample determiner 208, the loss value generator 212, the perturbed output aggregator 210, the stability-enhanced ML optimizer 214, and/or the ML model quality assessor 216 of the ML model stability assessment and training system 200.

In some aspects, as shown in FIG. 7, the process 700 may include steps 504, 506, 508, 510, and 612, which may be the same as or similar to the steps 504, 506, 508, 510, and 612 of the process 600 described above. In some aspects, as shown in FIG. 7, the process 700 may include the optional step 502, which may be the same as or similar to the optional step 502 of the processes 500 and 600 described above.

In some aspects, as shown in FIG. 7, the process 700 may include an optional step 714 in which the system 200 (e.g., the perturbed output aggregator 210 or the stability-enhanced ML optimizer 214 of the system 200) determines a relative perturbed output yₙ^{rel} based on the aggregate perturbed output yₙ of the Q perturbations for the input sample n. In some aspects, the relative perturbed output yₙ^{rel} may be determined as yₙ/Δy, where Δy is the difference between the largest output of the ML model 202 and the smallest output of the ML model 202.

In some aspects, as shown in FIG. 7, the process 700 may include a step 716 in which the system 200 determines whether the input sample n is the Nth input sample. In some aspects, if the input sample n is not the Nth input sample, the process 700 may proceed from the step 716 to a step 718 in which the system 200 increments n and resets q to 1, and the process 700 may then proceed to repeat steps 504 through 714 for the next input sample of the N input samples. In some aspects, if the input sample n is the Nth input sample, the process 700 may proceed from the step 716 to an optional step 720.

In some aspects, as shown in FIG. 7, the process 700 may include the optional step 720. In some aspects, the step 720 may include the system 200 (e.g., the stability-enhanced ML optimizer 214 of the system 200) aggregating the relative perturbed outputs yₙ^{rel} to determine an estimate of the stability of the ML model 202. In some aspects, aggregating the relative output variations yₙ^{rel} in step 720 may include using an aggregation function y^{rel}=aggregate (yₙ^{rel}) to aggregate the relative output variations yₙ^{rel}. In some aspects, aggregating the relative perturbed outputs yₙ^{rel} may include determining a mean of the relative perturbed outputs yₙ^{rel}, and the estimate of the stability of the ML model 202 may be the mean of the relative perturbed outputs yₙ^{rel}. In some aspects, aggregating the relative perturbed outputs yₙ^{rel} may include determining a standard deviation of the relative perturbed outputs yₙ^{rel}, and the estimate of the stability of the ML model 202 may be the standard deviation of the relative perturbed outputs yₙ^{rel}. In some aspects, aggregating the relative perturbed outputs yₙ^{rel} may include determining a variance of the relative perturbed outputs, and the estimate of the stability of the ML model 202 may be the variance of the relative perturbed outputs yₙ^{rel}. In some aspects, aggregating the relative perturbed outputs yₙ^{rel} may include determining a maximum relative perturbed output of the relative perturbed outputs yₙ^{rel}, and the estimate of the stability of the ML model 202 may be the maximum relative perturbed output of the relative perturbed outputs yₙ^{rel}. In some aspects, aggregating the relative perturbed outputs yₙ^{rel} may include determining a minimum relative perturbed output of the relative perturbed outputs yₙ^{rel}, and the estimate of the stability of the ML model 202 may be the minimum aggregate perturbed output of the relative perturbed outputs yₙ^{rel}. In some aspects, aggregating the relative perturbed outputs yₙ^{rel} may include determining a median of the relative perturbed outputs yₙ^{rel}, and the estimate of the stability of the ML model 202 may be the median of the relative perturbed outputs yₙ^{rel}.

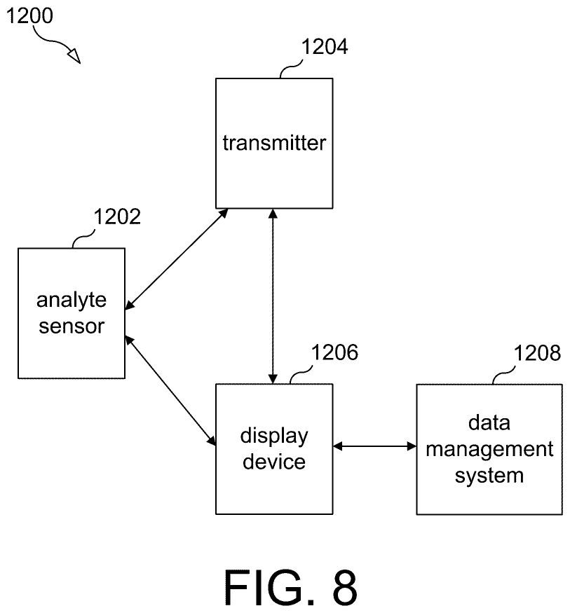

In some blood glucose level prediction aspects in which the ML model inputs include one or more ISF glucose levels and associated time stamps, one or more analyte monitoring systems 1200, such as, for example and without limitation, the analyte monitoring system 1200 shown in FIG. 8, may be used to generate the N input samples of the training data set used to train and/or assess the ML model 202. In some aspects, after the ML model 202 is trained, the ML model 202 may be used by an analyte monitoring system 1200 to predict blood glucose levels based on ISF glucose levels calculated by the analyte monitoring system 1200.

In some aspects, as shown in FIG. 8, the analyte monitoring system 1200 may be a continuous analyte monitoring system (e.g., a continuous glucose monitoring system). In some aspects, the analyte monitoring system 1200 may include an analyte sensor 1202, a transceiver 1204, a display device 1206, and/or a data management system (DMS) 1208 hosted by a remote server or network attached storage hardware.

In some aspects, the sensor 1200 may be small, fully subcutaneously implantable sensor measures analyte (e.g., glucose) concentrations in a medium (e.g., interstitial fluid) of a living animal (e.g., a living human). However, this is not required, and, in some alternative aspects, the analyte sensor 1202 may be a partially implantable (e.g., transcutaneous) sensor or a fully external sensor. In some aspects, the analyte sensor 1202 may be powered by (a) one or more charge storage devices (e.g., one or more batteries) included in the analyte sensor 1202 and/or (b) power received from a source (e.g., the transceiver 1204 and/or the display device 1206) external to the analyte sensor 1202. In some non-limiting aspects, the analyte sensor 1202 may include one or more optical sensors (e.g., one or more fluorometers). In some aspects, the analyte sensor 1202 may be a chemical or biochemical sensor. In some aspects, the analyte sensor 1202 may be a radio frequency identification (RFID) device.

In some aspects, the transceiver 1204 may be an externally worn transceiver (e.g., attached via an armband, wristband, waistband, or adhesive patch). In some aspects, the transceiver 1204 may remotely power and/or communicate with the sensor to initiate and receive the measurements (e.g., via near field communication (NFC) or far field communication). However, this is not required, and, in some alternative aspects, the transceiver 1204 may power and/or communicate with the sensor 1202 via one or more wired connections. In some aspects, the transceiver 1204 may be a smartphone (e.g., an NFC-enabled smartphone). In some aspects, the transceiver 1204 may communicate information (e.g., one or more analyte concentrations and/or one or more sensor measurements) wirelessly (e.g., via a Bluetooth™ communication standard such as, for example and without limitation Bluetooth Low Energy) to a mobile medical application running on a display device 1206 (e.g., a smartphone such as, for example, an NFC-enabled smartphone).

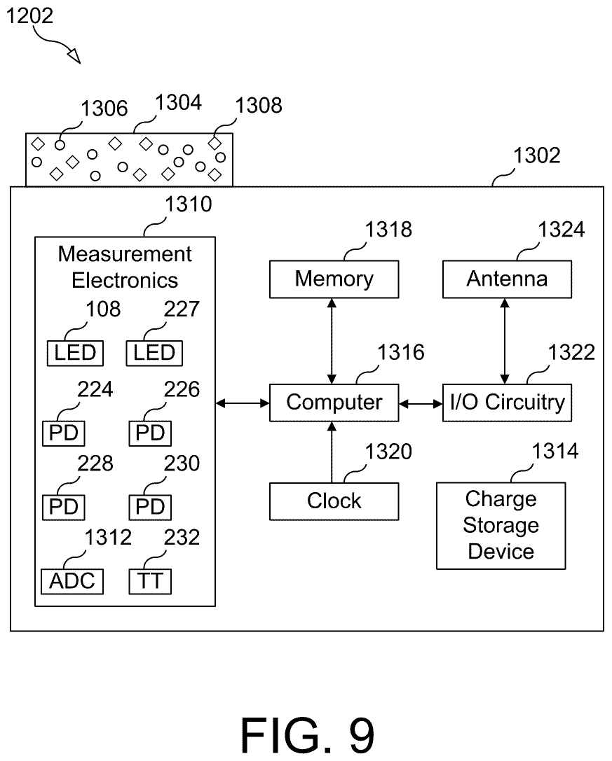

FIG. 9 illustrates an exemplary aspect in which the analyte sensor 1202 of the analyte monitoring system 1200 is a fully implantable electro-optical sensor. However, this is not required, and, in some alternative aspects, the analyte sensor 1202 may be a different type of analyte sensor (e.g., a transcutaneous electrochemical sensor). In some aspects, as shown in FIG. 9, the analyte sensor 1202 may include a sensor housing 1302 (i.e., body, shell, capsule, or encasement), which may be rigid and biocompatible. In some aspects, the sensor housing 1302 may be a silicon tube. However, this is not required, and, in other aspects, different materials and/or shapes may be used for the sensor housing 1302. In some aspects, the analyte sensor 1202 may include a transmissive optical cavity (e.g., within the sensor housing 1302). In some aspects, the transmissive optical cavity may be formed from a suitable, optically transmissive polymer material, such as, for example, acrylic polymers (e.g., polymethylmethacrylate (PMMA)). However, this is not required, and, in other aspects, different materials may be used for the transmissive optical cavity.

In some aspects, the analyte sensor 1202 may include one or more analyte and/or interferent indicators 1304, which may be, for example, polymer grafts or hydrogels coated, diffused, adhered, embedded, or grown on or in one or more portions of the exterior surface of the sensor housing 1302. In some aspects, the one or more analyte and/or interferent indicators 1304, may be porous and may allow the analyte (e.g., glucose) in a medium (e.g., interstitial fluid) to diffuse into the one or more analyte and/or interferent indicators 1304.

In some aspects, as shown in FIG. 9, the one or more analyte and/or interferent indicators 1304 may include analyte indicator molecules 1306 and/or interferent indicator molecules 1308 (e.g., degradation indicator molecules). In some aspects, analyte sensor 1202 may use the analyte indicator molecules 1306 to measure the presence, amount, and/or concentration of an analyte (e.g., glucose, oxygen, cardiac markers, low-density lipoprotein (LDL), high-density lipoprotein (HDL), or triglycerides). In some aspects, the analyte indicator molecules 1306 may use the interferent indicator molecules 1308 to measure in vivo (e.g., ROS induced) signal degradation. In some aspects, in the one or more analyte and/or interferent indicators 1304, the analyte indicator molecules 1306 and/or the interferent indicator molecules 1308 may be copolymerized into a single biocompatible hydrogel. In some aspects, the analyte indicator molecules 1306 and/or the interferent indicator molecules 1308 may have negligible spectral overlap and undergo similar degradation (e.g., similar degradation of boronic acids) in vivo.

In some aspects, the analyte indicator molecules 1306 may have one or more detectable properties (e.g., optical properties) that vary in accordance with (i) the amount or concentration of the analyte in proximity to the analyte and/or interferent indicator 1304 and (ii) an effect on the analyte indicator molecules 1306 (e.g., changes to the analyte indicator molecules 1306). In some aspects, the changes to the analyte indicator molecules 1306 may comprise the extent to which the analyte indicator molecules 1306 have degraded. In some aspects, the degradation may be (at least in part) ROS-induced oxidation. In some aspects, the analyte indicator molecules 1306 may be fluorescent analyte indicator molecules. In some aspects, the analyte indicator molecules 1306 may be distributed throughout the analyte and/or interferent indicator 1304. In some aspects, the analyte indicator molecules 1306 may be phenylboronic-based analyte indicator molecules. However, a phenylboronic-based analyte indicator is not required, and, in some alternative aspects, the analyte sensor 1202 may include different analyte indicator molecules, such as, for example and without limitation, glucose oxidase-based indicators, glucose dehydrogenase-based indicators, and glucose binding protein-based indicators.

In some aspects, the interferent indicator molecules 1308 may have one or more detectable properties (e.g., optical properties) that vary in accordance with changes to the interferent indicator molecules 1308. In some aspects, the interferent indicator molecules 1308 are not sensitive to the amount of concentration of the analyte in proximity to the analyte and/or interferent indicator 1304. That is, in some aspects, the one or more detectable properties of the interferent indicator molecules 1308 do not vary in accordance with the amount or concentration of the analyte in proximity to the analyte and/or interferent indicator 1304. However, this is not required, and, in some alternative aspects, the one or more detectable properties of interferent indicator molecules 1308 may vary in accordance with the amount or concentration of the analyte in proximity to the analyte and/or interferent indicator 1304.

In some aspects, the changes to the interferent indicator molecules 1308 may comprise the extent to which the interferent indicator molecules 1308 have degraded. In some aspects, the degradation may be (at least in part) ROS-induced oxidation. In some aspects, the interferent indicator molecules 1308 may be fluorescent interferent indicator molecules. In some aspects, the interferent indicator molecules 1308 may be distributed throughout the analyte and/or interferent indicator 1304. In some aspects, the interferent indicator molecules 1308 may be phenylboronic-based interferent indicator molecules. However, phenylboronic-based interferent indicator molecules are not required, and, in some alternative aspects, the analyte sensor 1202 may include different interferent indicator molecules 1308, such as, for example and without limitation, amplex red-based interferent indicator molecules, dichlorodihydrofluorescein-based interferent indicator molecules, dihydrorhodamine-based interferent indicator molecules, and scopoletin-based interferent indicator molecules.

In some aspects, the analyte sensor 1202 may measure changes to the analyte indicator molecules 1306 of an analyte and/or interferent indicator 1304 indirectly using the interferent indicator molecules 1308 of the analyte and/or interferent indicator 1304, which may by sensitive to degradation by reactive oxygen species (ROS) but not sensitive to the analyte. In some aspects, the interferent indicator molecules 1308 may have one or more optical properties that change with extent of oxidation and may be used as a reference for measuring and correcting for extent of oxidation of the analyte indicator molecules 1306. In some aspects, the extent to which the interferent indicator molecules 1308 have degraded may correspond to the extent to which the analyte indicator molecules 1306 have degraded. For example, in aspects, the extent to which the interferent indicator molecules 1308 have degraded may be proportional to the extent to which the analyte indicator molecules 1306 have degraded. In some aspects, the extent to which the analyte indicator molecules 1306 have degraded may be calculated based on the extent to which the interferent indicator molecules 1308 have degraded. In some aspects, the analyte monitoring system 1200 may correct for changes in the analyte indicator molecules 1306 using an empiric correlation established through laboratory testing.

In some aspects, the analyte sensor 1202 may include measurement electronics 1310 (e.g., optical measurement electronics). In some aspects, the measurement electronics 1310 may include one or more light sources and/or one or more photodetectors. For example, in some aspects, as shown in FIG. 9, the measurement electronics 1310 may include one or more first light sources 108 that emit first excitation light over a wavelength range that interacts with the analyte indicator molecules 1306 in the analyte and/or interferent indicator 1304. In some aspects, the first excitation light may be ultraviolet (UV) light. In some aspects, the analyte sensor 1202 may include one or more second light sources 227 that emit second excitation light over a wavelength range that interacts with the interferent indicator molecules 1308 in the analyte and/or interferent indicator 1304. In some aspects, the second excitation light may be, for example and without limitation, blue light.

In some aspects, an analyte (e.g., glucose) may bind reversibly to some of the analyte indicator molecules 1306, the analyte indicator molecules 1306 to which the analyte is bound may emit first emission light (e.g., fluorescent light) when irradiated by the first excitation light, and the analyte indicator molecules 1306 to which the analyte is not bound may not emit light (or emit only a small amount of light) when irradiated by the first excitation light. In some aspects, oxidation of the interferent indicator molecules 1308 may cause the interferent indicator molecules 1308 to emit second emission light (e.g., when irradiated by the second excitation light). In some aspects, oxidation of the interferent indicator molecules 1308 may additionally or alternatively cause the absorption of the interferent indicator molecules 1308 (e.g., absorption of the second excitation light by the interferent indicator molecules 1308) to change.

In some aspects, as shown in FIG. 9, the measurement electronics 1310 of the analyte sensor 1202 may also include one or more photodetectors 224, 226, 228 (e.g., photodiodes, phototransistors, photoresistors, or other photosensitive elements). In some aspects, the measurement electronics 1310 of the analyte sensor 1202 may include one or more signal photodetectors 224 sensitive to first emission light (e.g., fluorescent light) emitted by the analyte indicator molecules 1306 such that a signal generated by a signal photodetector 224 is indicative of the level of first emission light of the analyte indicator molecules 1306 and, thus, the amount of analyte of interest (e.g., glucose). In some aspects, the measurement electronics 1310 may include one or more reference photodetectors 226 sensitive to first excitation light that may be reflected from the analyte and/or interferent indicator 1304 such that a signal generated by a photodetector 226 in response thereto is indicative of the level of reflected first excitation light. In some aspects, the analyte sensor 1202 may include one or more interferent photodetectors 228 sensitive to second emission light (e.g., fluorescent light) emitted by the interferent indicator molecules 1308 such that a signal generated by an interferent photodetector 228 in response thereto that is indicative of the level of second emission light of the interferent indicator molecules 1308 and, thus, the amount of degradation (e.g., oxidation). In some aspects, the one or more signal photodetectors 224 may be sensitive to second excitation light that may be reflected from the analyte and/or interferent indicator 1304. In this way, the one or more signal photodetectors 224 may act as reference photodetectors when the one or more light sources 227 are emitting second excitation light.

However, it is not required that the one or more signal photodetectors 224 act as reference photodetectors when the one or more light sources 227 are emitting second excitation light. In some alternative aspects, as shown in FIG. 9, the measurement electronics 1310 of the analyte sensor 1202 may include one or more second reference photodetectors 230 that act as reference photodetectors when the one or more light sources 227 are emitting second excitation light. In some aspects, the one or more second reference photodetectors 230 may be sensitive to second excitation light that may be reflected from the analyte and/or interferent indicator 1304 such that a signal generated by a photodetector 230 in response thereto is indicative of the level of reflected second excitation light.

In some aspects, one or more of the photodetectors 224, 226, 228, 230 may be covered by one or more filters that allow only a certain subset of wavelengths of light to pass through and reflect (or absorb) the remaining wavelengths. In some aspects, one or more filters on the one or more signal photodetectors 224 may allow only a subset of wavelengths corresponding to first emission light and/or the reflected second excitation light. In some aspects, one or more filters on the one or more reference photodetectors 226 may allow only a subset of wavelengths corresponding to the reflected first excitation light. In some aspects, one or more filters on the one or more interferent photodetectors 228 may allow only a subset of wavelengths corresponding to second emission light. In some aspects in which the analyte sensor 1202 includes one or more second reference photodetectors 230, one or more filters on the one or more second reference photodetectors 230 may allow only a subset of wavelengths corresponding to the reflected second excitation light.

In some aspects, as shown in FIG. 9, the measurement electronics 1310 of the analyte sensor 1202 may include one or more temperature transducers 232. In some aspects, the measurement electronics 1310 may include one or more light source drivers, one or more amplifiers, one or more analog-to-digital convertors (ADCs) 1312, one or more comparators, and/or one or more multiplexors. In some aspects, the one or more ADCs 1312 may convert analog signals output by the photodetectors 224, 226, 228, 230 and/or one or more temperature transducers 232 to digital signals.

In some aspects, as shown in FIG. 9, the analyte sensor 1202 may include a charge storage device 1314, a computer 1316, a memory 1318, a clock 1320, an input/output (I/O) circuit 1322, and/or an antenna 1324. In some aspects, the I/O circuit 1322 may include I/O digital circuitry and/or I/O analog circuitry. In some aspects, the antenna 1324 may be electrically connected to the I/O circuit 1322, which may use current flowing through the antenna 1324 to generate power for the sensor 1202 and/or to extract data from the current. In some aspects, the 1322 may also convey data (e.g., to the transceiver 1204 and/or display device 1206) by modulating the current the flowing through the antenna 1324. In some aspects, the I/O circuit 1322 may be electrically connected to and be powered by the charge storage device 1314. In some aspects, although not shown in FIG. 9, the analyte sensor 1202 may include multiple sensing devices, and the antenna 1324 may be electrically connected to the circuitry of the multiple sensing devices.

In some aspects, the charge storage device (CSD) 1314 may provide power to the clock 1320 and to the computer 1316. In some aspects, the CSD-powered clock 1320 may provide a continuous clock for driving circuitry of the sensor 1202 even when the sensor 1202 is not receiving power from an external device (e.g., the transceiver 1204 and/or the display device 1206). In some aspects, the computer 1316 may use the continuous clock output of the clock 1320 to keep track of time and initiate autonomous, self-powered analyte measurements when appropriate (e.g., at periodic intervals, such as, for example, every minute, every two minutes, every 5 minutes, every 10 minutes, every 15 minutes, every half-hour, every hour, every two hours, every six hours, every twelve hours, or every day). In some aspects, the computer 1316 may control the measurement electronics 1310 to perform an autonomous analyte measurement sequence, and the results of the autonomous analyte measurement may be stored in the memory 1318. The autonomous analyte measurements may be stored in the memory 1318. In some aspects, the I/O circuit 1322 may convey one or more of the stored measurements to the external device (e.g., the transceiver 1204 and/or the display device 1206) at a later time. For example, in some request aspects, the I/O circuit 1322 may convey one or more of the stored measurements in response to the analyte sensor 1202 receiving and decoding a measurement data request from the transceiver 1204 and/or the display device 1206. In some alternative aspects, the I/O circuit 1322 may convey one or more of the stored measurements in response to detecting that the transceiver 1204 and/or display device 1206 is present (e.g., when an electrodynamic field generated by the transceiver 1204 and/or display device 1206 induces a current in the antenna 1324 of the analyte sensor 1202). In some aspects in which the analyte sensor 1202 include multiple sensing devices, although not shown in FIG. 9, the CSD 1314 may be electrically connected to the circuitry of the multiple sensing devices.

In some aspects, the memory 1318 may be a nonvolatile storage medium. In some aspects, the memory 1318 may be an electrically erasable programmable read only memory (EEPROM). However, in some alternative aspects, other types of nonvolatile storage media, such as flash memory, may be used. In some aspects, the memory 1318 may include an address decoder. In some aspects, the memory 1318 may store measurement information autonomously generated while the sensor 1202 is powered from the charge storage device 1314. In some aspects, the memory 1320 may additionally or alternatively store one or more time-stamps identifying when the measurement data was generated, sensor calibration data, a unique sensor identification, setup information, and/or integrated circuit calibration data. In some aspects, the unique identification information may, for example, enable full traceability of the sensor 1202 through its production and subsequent use.

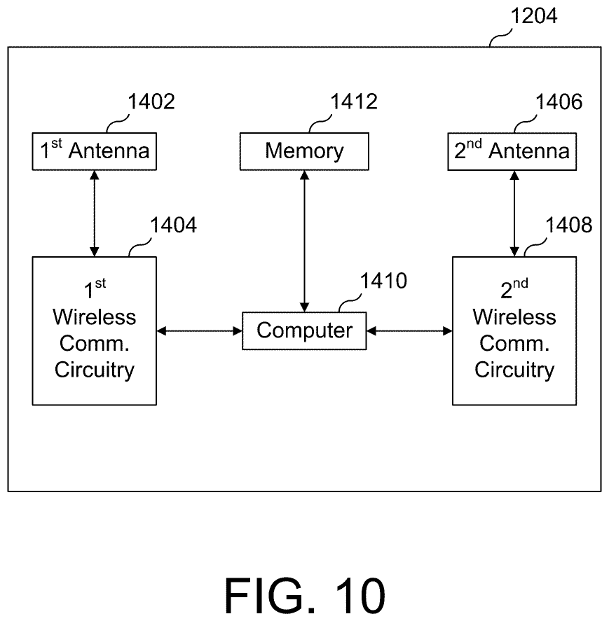

FIG. 10 illustrates an exemplary aspect in which the transceiver 1204 of the analyte monitoring system 1200 is a wireless transceiver (e.g., a wireless on-body transceiver). However, this is not required, and, in some alternative aspects, the transceiver 1204 may be a different type of transceiver (e.g., a transceiver having a wired connection to the analyte sensor 1202). In some aspects, as shown in FIG. 10, the transceiver 1204 may include a first antenna 1402, first wireless communication circuitry 1404, a second antenna 1406, second wireless communication circuitry 1408, a computer 1410, and/or a memory 1412. In some aspects, the computer 1410 may control the overall operation of the transceiver 1204.

In some aspects, the transceiver 1204 may include a sensor interface device. In some aspects, the sensor interface device of the transceiver 1204 may include the first antenna 1402 and the first wireless communication circuitry 1404. In some aspects, the first wireless communication circuitry 1404 may enable the transceiver 1204 to communicate directly with the analyte sensor 1202. In some aspects, the transceiver 1204 and the sensor 1202 may communicate using NFC (e.g. at a frequency of 13.56 MHz). In some aspects, the first antenna 1402 of the transceiver 1204 may include an inductor (e.g. flat antenna, loop antenna, etc.) that is configured to permit adequate field strength to be achieved when brought within adequate physical proximity to the antenna 1324 of the sensor 1202.

In some aspects, the transceiver 1204 may use the first antenna 1402 and the first wireless communication circuitry 1404 to receive sensor data from the analyte sensor 1202. In some aspects, the computer 1410 may store the received sensor data in the memory 1412. In some aspects, the memory 1412 may be non-volatile and/or capable of being electronically erased and/or rewritten. In some aspects, the memory 1412 may be, for example and without limitations a Flash memory.

In some aspects, the received sensor data may include light measurements, temperature measurements, and time stamps. In some aspects, the computer 1410 may use the sensor data to predict blood glucose levels. In some aspects, the computer 1410 may use the trained ML model 202 to predict blood glucose levels. In some aspects, the computer 1410 may use the sensor data to calculate ISF glucose levels, and the ML model 202 may predict blood glucose levels based on the calculated ISF glucose levels. In some alternative aspects, the ML model 202 may predict blood glucose levels based on the sensor data directly. In some aspects, the computer 1410 may store the predicted blood glucose levels in the memory 1412.

In some aspects, the transceiver 1204 may include a display interface device. In some aspects, the display device interface device may include the second antenna 1406 and the second wireless communication circuitry 1408. In some aspects, the second wireless communication circuitry 1408 may enable wireless communication by the transceiver 1204 with one or more external devices, such as, for example, one or more personal computers, one or more other transceivers 1204, and/or display devices 1206 via the second antenna 1406. In some aspects, the second wireless communication circuitry 1408 may employ one or more wireless communication standards to wirelessly transmit data. The wireless communication standard employed may be any suitable wireless communication standard, such as an ANT standard, a Bluetooth standard, or a Bluetooth Low Energy (BLE) standard (e.g., BLE 4.0). In some aspects, the second antenna 1406 may be, for example and without limitation, a Bluetooth antenna.

In some aspects in which the transceiver 1204 predicts blood glucose levels, the transceiver 1204 may use the second antenna 1406 and the second wireless communication circuitry 1408 to convey predicted blood glucose levels to the display device 1206. In some aspects in which the transceiver 1204 predicts and conveys blood glucose levels, the transceiver 1204 may additionally convey the sensor data to the display device 1206. In some alternative aspects, the transceiver 1204 may not predict blood glucose levels. In some aspects in which the transceiver 1204 does not predict blood glucose levels, the transceiver 1204 may use the second antenna 1406 and the second wireless communication circuitry 1408 to convey sensor data to the display device 1206, and the display device 1206 may use the sensor data to predict blood glucose levels.

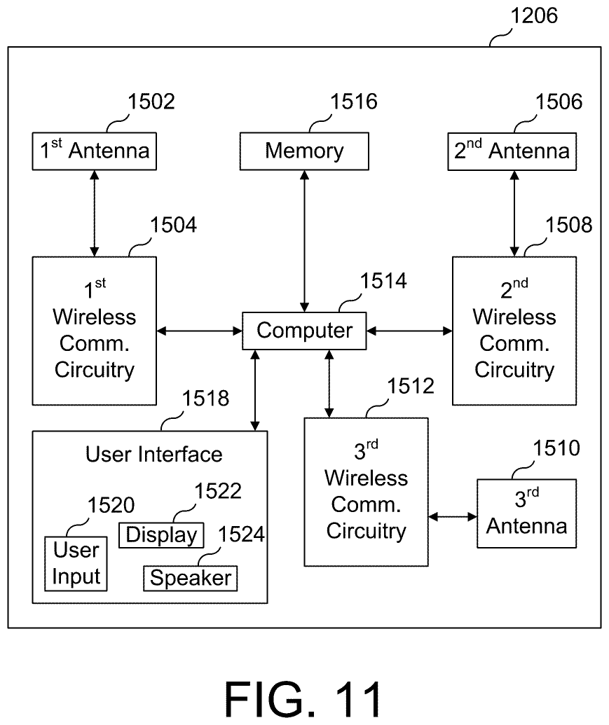

FIG. 11 is a block diagram of the display device 1206 of the analyte monitoring system 1200 according to some aspects. In some aspects, as shown in FIG. 11, the display device 1206 may include a first antenna 1502, first wireless communication circuitry 1504, second antenna 1506, second wireless communication circuitry 1508, third antenna 1510, third wireless communication circuitry 1512, a computer 1514, a memory 1516, and/or a user interface 1518. In some aspects, the computer 1514 may control the overall operation of the display device 1206.

In some aspects, the display device 1206 may include a sensor interface device. In some aspects, the sensor interface device of the display device 1206 may include the first antenna 1502 and the first wireless communication circuitry 1504. In some aspects, the first wireless communication circuitry 1504 may enable the display device 1206 to communicate directly with the analyte sensor 1202. In some aspects, the display device 1206 and the sensor 1202 may communicate using NFC (e.g. at a frequency of 13.56 MHz). In some aspects, the first antenna 1502 of the display device 1206 may include an inductor (e.g. flat antenna, loop antenna, etc.) that is configured to permit adequate field strength to be achieved when brought within adequate physical proximity to the antenna 1324 of the sensor 1202.

In some aspects, the display device 1206 may use the first antenna 1502 and the first wireless communication circuitry 1504 to receive sensor data from the analyte sensor 1202. In some aspects, the computer 1514 may store the received sensor data in the memory 1516. In some aspects, the memory 1516 may be non-volatile and/or capable of being electronically erased and/or rewritten. In some aspects, the memory 1516 may be, for example and without limitations a Flash memory.

In some aspects, the received sensor data may include light measurements, temperature measurements, and time stamps. In some aspects, the computer 1514 may use the sensor data to predict blood glucose levels. In some aspects, the computer 1514 may use the trained ML model 202 to predict blood glucose levels. In some aspects, the computer 1514 may use the sensor data to calculate ISF glucose levels, and the ML model 202 may predict blood glucose levels based on the calculated ISF glucose levels. In some alternative aspects, the ML model 202 may predict blood glucose levels based on the sensor data directly. In some aspects, the computer 1514 may store the predicted blood glucose levels in the memory 1516.

In some aspects, the display device 1206 may include a transceiver interface device. In some aspects, the transceiver interface device may include the second antenna 1506 and the second wireless communication circuitry 1508. In some aspects, the second wireless communication circuitry 1508 may enable wireless communication by the display device 1206 with one or more external devices, such as, for example, one or more personal computers, one or more transceivers 1204, and/or one or more other display devices 1206 via the second antenna 1506. In some aspects, the second wireless communication circuitry 1508 may employ one or more wireless communication standards to wirelessly transmit data. The wireless communication standard employed may be any suitable wireless communication standard, such as an ANT standard, a Bluetooth standard, or a Bluetooth Low Energy (BLE) standard (e.g., BLE 4.0). In some aspects, the second antenna 1506 may be, for example and without limitation, a Bluetooth antenna.

In some aspects, the display device 1206 may use the second antenna 1506 and the second wireless communication circuitry 1508 to receive sensor data and/or predicted blood glucose levels from the transceiver 1204. In some aspects, the computer 1514 may store the received sensor data and/or the received predicted blood glucose levels in the memory 1516. In some aspects, the computer 1514 may use the sensor data to predict blood glucose levels. In some aspects (e.g., some aspects in which the display device 1206 does not receive predicted blood glucose levels from transceiver 1204), the computer 1514 may use the trained ML model 202 to predict blood glucose levels based on the sensor data received from the transceiver 1204. In some aspects, the computer 1514 may use the sensor data to calculate ISF glucose levels, and the ML model 202 may predict blood glucose levels based on the calculated ISF glucose levels. In some alternative aspects, the ML model 202 may predict blood glucose levels based on the sensor data directly. In some aspects, the computer 1514 may store the predicted blood glucose levels in the memory 1516.

In some aspects in which the display device 1206 includes the third antenna 1510 and the third wireless communication circuitry 1512, the third antenna 1510 and the third wireless communication circuitry 1512 may enable the display device 1206 to communicate with one or more remote devices (e.g., smartphones, servers, and/or personal computers) via wireless local area networks (e.g., Wi-Fi), cellular networks, and/or the Internet. In some aspects, the third wireless communication circuitry 1512 may employ one or more wireless communication standards to wirelessly transmit data. In some aspects, the third antenna 1510 may be, for example and without limitation, a Wi-Fi antenna and/or one or more cellular antennas.

In some aspects in which the display device 1206 includes the user interface 1518, the user interface 1518 may include a display 1522 and/or a user input 1520. In some aspects, the display 1522 may be a liquid crystal display (LCD) and/or light emitting diode (LED) display. In some aspects, the user input 1520 may include one or more buttons, a keyboard, a keypad, and/or a touchscreen. In some aspects, the computer 1514 may control the display 1522 to display data (e.g., predicted blood analyte levels, blood analyte trend information, alerts, alarms, and/or notifications). In some aspects, the user interface 1518 may include one or more of a speaker 1524 (e.g., a beeper) and a vibration motor, which may be activated, for example, in the event that a condition (e.g., a hypoglycemic or hyperglycemic condition) is met.

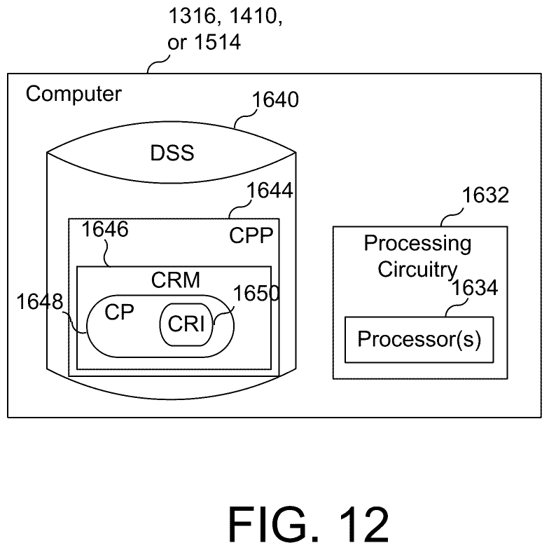

FIG. 12 is a block diagram of an aspect of a computer (e.g., the computer 1316 of the analyte sensor 1202, the computer 1410 of the transceiver 1204, and/or the computer 1514 of the display device 1206) of the analyte monitoring system 1200 or of the ML) model stability assessment and training system 200. As shown in FIG. 12, in some aspects, the computer may include processing circuitry 1632 and/or one or more circuits, such as an application specific integrated circuit (ASIC), field-programmable gate arrays (FPGAs), a logic circuit, and the like. The processing circuitry 1632 may include one or more processors 1634 (e.g., one or more general purpose microprocessors). In some aspects, the computer may include a data storage system (DSS) 1640. The DSS 1640 may include one or more non-volatile storage devices and/or one or more volatile storage devices (e.g., random access memory (RAM)). In aspects where the computer includes processing circuitry 1632, the DSS 1640 may include a computer program product (CPP) 1644. CPP 1644 may include or be a computer readable medium (CRM) 1646. The CRM 1646 may store a computer program (CP) 1648 comprising computer readable instructions (CRI) 1650. In some aspects in which the computer is the computer 1514 of the display device 1206, the CRM 1646 may store, among other programs, the MMA, and the CRI 1650 may include one or more instructions of the MMA. The CRM 1646 may be a non-transitory computer readable medium, such as, but not limited, to magnetic media (e.g., a hard disk), optical media (e.g., a DVD), solid state devices (e.g., random access memory (RAM) or flash memory), and the like. In some aspects, the CRI 1650 of computer program 1648 may be configured such that when executed by processing circuitry 1632, the CRI 1650 causes the computer to perform steps described above (e.g., steps described above with reference to processes 500, 600, and 700). In other aspects, the computer may be configured to perform steps described herein without the need for a computer program. That is, for example, the computer may consist merely of one or more ASICs. Hence, the features of the aspects described herein may be implemented in hardware and/or software.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel. Similarly, although steps 516 and 518 of the process 500 are shown as being performed in parallel with steps 504 through 514 for each input sample n, this is not required, and, in some alternative aspects, steps 516 and 518 of the process 500 may be performed in sequence with steps 504 through 514 (e.g., before or after steps 504 through 514) for each input sample n.

What is claimed is:

1. A method comprising:
for each input sample n of N input samples:
for each perturbation q of Q perturbations:
determining a perturbed input sample n_{q} by perturbing the input sample n; and
using a machine learning (ML) model to obtain a perturbed output y_{qn} based on the perturbed input sample n_{q}; and
aggregating the perturbed outputs y_{qn} of the Q perturbations to obtain an aggregate perturbed output yₙ of the Q perturbations for the input sample n;
wherein N is an integer greater than 1, and Q is an integer greater than or equal to 1.

2. The method of claim 1, further comprising adjusting the ML model based on the aggregate perturbed outputs yₙ for the N input samples.

3. The method of claim 2, wherein adjusting the ML model based on the aggregate perturbed outputs yₙ for the N input samples comprises:
determining, for each input sample n of the N input samples, a gradient and a Hessian of the aggregate perturbed output yₙ of the Q perturbations for the input sample n; and
adjusting the ML model based on the gradients and Hessians.

4. The method of claim 3, wherein adjusting the ML model based on the gradients and Hessians comprises for each input sample n of the N input samples:
combining the gradient and the Hessian of the aggregate perturbed output yₙ of the Q perturbations for the input sample n with a gradient and Hessian, respectively, of a performance-based loss function to create an overall loss function;
using an optimization algorithm to determine parameters of the ML model the minimize the overall loss function; and
adjusting the ML model to have the determined parameters of the ML model.

5. The method of claim 3, wherein aggregating the perturbed outputs y_{qn} of the Q perturbations for the input sample n comprises determining a mean y̅ₙ̅ of the perturbed outputs y_{qn} of the Q perturbations.

6. The method of claim 3, wherein aggregating the perturbed outputs y_{qn} of the Q perturbations for the input sample n comprises determining a standard deviation of the perturbed outputs y_{qn} of the Q perturbations for the input sample n, and the aggregate perturbed output yₙ of the Q perturbations for the input sample n is the standard deviation.

7. The method of claim 3, wherein aggregating the perturbed outputs y_{qn} of the Q perturbations for the input sample n comprises determining a variance of the perturbed outputs y_{qn} of the Q perturbations for the input sample n, and the aggregate perturbed output yₙ of the Q perturbations for the input sample n is the variance.

8. The method of claim 7, wherein the variance v of the perturbed outputs y_{qn} of the Q perturbations for the input sample n is calculated as
$$\frac{\sum {( {y}_{qn} - \overline{{y}_{n}} )}^{2}}{Q - 1} .$$

9. The method of claim 8, wherein the gradient of the aggregate perturbed output yₙ of the Q perturbations for the input sample n is calculated as
$$\frac{\partial v}{\partial {y}_{qn}} = \frac{2 {\sum }_{q} ( {y}_{qn} - \overline{{y}_{n}} )}{Q - 1} .$$

10. The method of claim 8, wherein the gradient of the aggregate perturbed output yₙ of the Q perturbations for the input sample n is calculated as
$$\frac{\partial v}{\partial {y}_{qn}} = \frac{2 {\sum }_{q} ( \vert {y}_{qn} - \overline{{y}_{n}} \vert )}{Q - 1} .$$

11. The method of claim 8, wherein the gradient of the aggregate perturbed output yₙ of the Q perturbations for the input sample n is calculated in polar coordinates, and the phase information is discarded.

12. The method of claim 9, wherein the Hessian of the aggregate perturbed output yₙ of the Q perturbations for the input sample n is calculated as
$$\frac{{\partial }^{2} v}{{\partial }^{2} {y}_{qn}} = \frac{2 Q}{Q - 1} .$$

13. The method of claim 1, further comprising aggregating the aggregate perturbed outputs yₙ for the N input samples to determine an estimate of the stability of the ML model.

14. The method of claim 13, wherein aggregating the perturbed outputs y_{qn} of the Q perturbations for the input sample n comprises determining a mean y̅ₙ̅ of the perturbed outputs y_{qn} of the Q perturbations for the input sample n.

15. The method of claim 13, wherein aggregating the perturbed outputs y_{qn} of the Q perturbations for the input sample n comprises determining a standard deviation of the perturbed outputs y_{qn} of the Q perturbations for the input sample n, and the aggregate perturbed output yₙ of the Q perturbations for the input sample n is the standard deviation of the perturbed outputs y_{qn} of the Q perturbations for the input sample n.

16. The method of claim 13, wherein aggregating the perturbed outputs y_{qn} of the Q perturbations for the input sample n comprises determining a variance v of the perturbed outputs y_{qn} of the Q perturbations for the input sample n, and the aggregate perturbed output yₙ of the Q perturbations for the input sample n is the variance v of the perturbed outputs y_{qn} of the Q perturbations for the input sample n.

17. The method of claim 16, wherein the variance v of the perturbed outputs y_{qn} of the Q perturbations for the input sample n is calculated as
$$\frac{\sum {( {y}_{qn} - \overline{{y}_{n}} )}^{2}}{Q - 1} .$$

18. The method of claim 13, wherein aggregating the perturbed outputs y_{qn} of the Q perturbations for the input sample n comprises determining a maximum output of the perturbed outputs y_{qn} of the Q perturbations for the input sample n, and the aggregate perturbed output yₙ of the Q perturbations for the input sample n is the maximum output of the perturbed outputs y_{qn} of the Q perturbations for the input sample n.

19. The method of claim 13, wherein aggregating the perturbed outputs y_{qn} of the Q perturbations for the input sample n comprises determining a minimum output of the perturbed outputs y_{qn} of the Q perturbations for the input sample n, and the aggregate perturbed output yₙ of the Q perturbations for the input sample n is the minimum output of the perturbed outputs y_{qn} of the Q perturbations for the input sample n.

20. The method of claim 13, wherein aggregating the perturbed outputs y_{qn} of the Q perturbations for the input sample n comprises determining a median of the perturbed outputs y_{qn} of the Q perturbations for the input sample n.

21. The method of claim 1, further comprising, for each input sample n of the N input samples, determining a relative perturbed output yₙ^{rel} based on the aggregate perturbed output yₙ of the Q perturbations for the input sample n.

22. The method of claim 21, wherein the relative perturbed output yₙ^{rel} is determined as yₙ/Δy, where Δy is the difference between the largest output of the ML model and the smallest output of the ML model.

23. The method of claim 21, further comprising aggregating the relative perturbed outputs to determine an estimate of the stability of the ML model.

24. The method of claim 1, wherein perturbing the input sample n to determine the perturbed input sample n_{q} comprises, for each feature m of M features of the input sample n:
determining a perturbation within an input sample feature perturbation range sₘ for the feature m; and
applying the perturbation on the feature m of the input sample n to obtain a perturbed input sample feature m_{q};
wherein the perturbed input sample n_{q} comprises the perturbed input sample features m_{q}, and M is an integer greater than or equal to 1.

25. The method of claim 24, wherein the perturbation within the input sample feature perturbation range sₘ for the feature m is determined using a sampling scheme.

26. The method of claim 24, further comprising determining the input sample feature perturbation range sₘ for the feature m.

27. The method of claim 26, wherein determining the input sample feature perturbation range sₘ for the feature m comprises multiplying a feature value range Δm for the feature m of the input sample by a fractional perturbation size S.

28. An apparatus configured to:
for each input sample n of N input samples:
for each perturbation q of Q perturbations:
determine a perturbed input sample n_{q} by perturbing the input sample n; and
use a machine learning (ML) model to obtain a perturbed output y_{qn} based on the perturbed input sample n_{q}; and
aggregate the perturbed outputs y_{qn} of the Q perturbations to obtain an aggregate perturbed output yₙ of the Q perturbations for the input sample n;
wherein N is an integer greater than 1, and Q is an integer greater than or equal to 1.

29. The apparatus of claim 28, wherein the apparatus is further configured to adjust the ML model based on the aggregate perturbed outputs yₙ for the N input samples.

30. The apparatus of claim 28, wherein the apparatus is further configured to aggregate the aggregate perturbed outputs yₙ for the N input samples to determine an estimate of the stability of the ML model.

31. The apparatus of claim 28, wherein the apparatus is further configured to, for each input sample n of the N input samples, determine a relative perturbed output yₙ^{rel} based on the aggregate perturbed output yₙ of the Q perturbations for the input sample n.

32. The apparatus of claim 31, wherein the apparatus is further configured to aggregate the relative perturbed outputs to determine an estimate of the stability of the ML model.

33. The apparatus of claim 28, wherein the apparatus comprises processing circuitry and a memory, the memory includes instructions executable by the processing circuitry, whereby the apparatus is operative to perform the running, determining, and aggregating.
